(19) United States
(12) Patent Application Publication
(10) Pub. No.: US 2008/0201319 A1
(43) Pub. Date: Aug. 21, 2008

(54) Method, system and computer software for using an XBRL medical record for diagnosis, treatment, and insurance coverage

(76) Inventor: Richard Timothy McNamar, Falls Church, VA (US)

Correspondence Address: FOLEY AND LARDNER LLP;SUITE 500, 3000 K STREET NW, WASHINGTON, DC, 20007, US

(21) Appl. No.: 11/790,487

(22) Filed: Apr. 25, 2007

Related U.S. Application Data
(60) Provisional application No. 60/794,533, filed on Apr. 25, 2006.
(60) Provisional application No. 60/794,821, filed on Apr. 26, 2006.
(60) Provisional application No. 60/794,835, filed on Apr. 26, 2006.
(60) Provisional application No. 60/794,838, filed on Apr. 26, 2006.
(60) Provisional application No. 60/794,836, filed on Apr. 26, 2006.
(60) Provisional application No. 60/794,858, filed on Apr. 26, 2006.
(60) Provisional application No. 60/794,822, filed on Apr. 26, 2006.
(60) Provisional application No. 60/794,834, filed on Apr. 26, 2006.
(60) Provisional application No. 60/841,529, filed on Sep. 1, 2006.
(60) Provisional application No. 60/844,674, filed on Sep. 15, 2006.
(60) Provisional application No. 60/845,777, filed on Sep. 20, 2006.
(60) Provisional application No. 60/908,050, filed on Mar. 26, 2007.

(51) Int. Cl. G06F 7/06; G06F 17/30

(52) U.S. Cl. 707/5; 707/200; 707/E17.017

(57) ABSTRACT

A method, system and program product for integrating intelligence and business systems, the method comprising: receiving a search query; searching, using the search query, a plurality of XBRL data fields in records in a plurality of different data repositories, with each of the XBRL data fields having metadata representing attributes at the data value level based on context data according to an information taxonomy, and with links formed between and/or among at least two items selected from one or more of the categories of data fields, metadata, and components associated with the data fields, the searching obtaining a search result; triggering the creation of an electronic agency communication of at least a partial version of the search result; and communicating the at least partial version of the search result; wherein the content or addressee of the electronic agency communication is determined, at least in part, by the value of an importance factor related to one or more data items returned in the search results. Further embodiments relate to one or more XBRL forms.

### CROSS-REFERENCE TO RELATED PATENT APPLICATIONS

This application claims priority from Provisional U.S. Application 60/794,533, filed Apr. 25, 2006, Provisional U.S. Application 60/794,858, filed Apr. 26, 2006, Provisional U.S. Application 60/794,821, filed Apr. 26, 2006, Provisional U.S. Application 60/794,838, filed Apr. 26, 2006, Provisional U.S. Application 60/794,834, filed Apr. 26, 2006, Provisional U.S. Application 60/794,835, filed Apr. 26, 2006, Provisional U.S. Application 60/794,836, filed Apr. 26, 2006, Provisional U.S. Application 60/794,822, filed Apr. 26, 2006, Provisional U.S. Application 60/841,529, filed Sep. 1, 2006, Provisional U.S. Application 60/844,674, filed Sep. 15, 2006, Provisional U.S. Application 60/845,777, filed Sep. 20, 2006, from Provisional U.S. Application 60/908,050, filed Mar. 26, 2007, all being incorporated herein by reference in its entirety

### BACKGROUND OF THE INVENTION

Most law enforcement and intelligence gathering today is paper based. All agencies have intelligence or case management computer systems, but they tend to be proprietary and unable to operate together.

On Mar. 16, 2006, the FBI announced that it was abandoning its previous intelligence system in favor of a new program called Sentinel. Director Robert S. Mueller, III, said, “Sentinel will strengthen the FBI's capabilities by replacing its primarily paper-based reporting system with an electronic system designed for information sharing. Sentinel will support our current priorities, including our number one priority: preventing terrorist attacks. At the same time, the system will be flexible and adaptable, to address future technological advances and changes in our mission and threat environment.

Sentinel will deliver an electronic information management system, automate workflow processes for the first time, and provide a user-friendly web-based interface to access and search across multiple databases. Sentinel will help the FBI manage information beyond the case-focus of the existing Automated Case Support (ACS), and will provide enhanced information sharing, search, and analysis capabilities. Sentinel will also facilitate information sharing with members of the law enforcement and intelligence communities.”

The FBI has a primarily paper based system and its new Sentinel program is not scheduled to be fully operational until 2009. The situation is even more complicated in terms of homeland security where paper-based and computer based systems cannot share their intelligence information. The systems from the: Customs Service; the Secret Service; Coast Guard; Drug Enforcement Agency; Border Patrol; Alcohol Firearms and Tobacco, Defense Intelligence Agency, National Security Agency, National Counterterrorism Center, DoD's Special Operations Command, and the Central Intelligence Agency are not interoperable. And, none of them can operate with the FBI.

While there are security reasons for some classified data not being fully exchanged between all of the agencies, the simple knowledge that one agency has identified an individual as “a person of interest” can not be automatically shared within an agency and between law enforcement agencies today.

The lack of electronic sharing of information is compounded by the lack of interoperability between and among state and local law enforcement agencies and the federal government. And the intelligence sharing between state and local law enforcement and federal is also not computerized or automatic.

Each agency has its own intelligence and case management system that is often an old legacy system, proprietary to the agency, and not compatible with the other law enforcement agencies computer systems. As a result, the field agents lack confidence in the computerized intelligence system, find it of little use, and often don't input data into the computer or search it in a timely manner. The case of Zacharias Moussaoui is a case in point. The field agent wrote a report that it was strange that a non-U.S. citizen was paying cash to take multi-engine airplane flying lessons, but had no interest in learning to take off or land. This information was in the FBI's possession over a month before Sep. 11, 2002, but it did not connect it with any other intelligence or act on it.

In the global war on terrorism, connecting the dots is the tip of the spear. The central problem in law enforcement and counter-terrorism agencies is the sharing and effective management of data. The existing law enforcement agencies' computerized information systems are incompatible. The essence of the inter-agency information-sharing problem is the lack of interoperability of the existing and disparate information systems. Today they simply can not electronically connect the dots. (See FIG. 1)

The situation is even more difficult in tracking documents and people internationally to produce a seamless set of intelligence databases for Homeland Security and FBI use. Efforts to track shipping invoices, ship and airplane manifests, ships crew logs, and related material to monitor movements of people and material in seaports, airports, and major freight terminals presents a major computer interoperability challenge.

The interoperability data management challenge is highlighted in the Rand Corporation monograph (126-C) on threat analysis. It focuses primarily on top-level architecture with only some discussion of data management as part of the solution. However, this has led to DoD's Defense Acquisition Performance Assessment Panel (DAPA) efforts to find a new way to “Connecting the Dots” in intelligence for “tracking and identifying problem acquisition personnel early in the process.” See http://www.acq/psd/mil/dapaproject. This is a high level effort being led by the OSD (Office of Secretary of Defense) indicating the Secretary's interest in this interoperability of intelligence data challenge.

While the federal-state-local law enforcement agencies have spent billions of dollars on computerized case management and record keeping systems over the years, they have not sought interoperability and no known system to make the systems interoperable has been identified. Prior to Sep. 11, 2001 there was not an emphasis on connecting the dots in counter terrorism intelligence and law enforcement. None of the existing systems is known to be interoperable.

### Additional Background

Individuals are continually confronted with forms to be completed in their personal life, in the work place, medical environment, military, etc. These forms typically have instructions, reference manuals, or directions as to how to complete the forms. The forms refer or reference the instructions, manuals, or guides, which are contained in separate paper documents or electronic files, e.g. a separate Word or PDF file.

The instructions to complete the blank space in the form are referenced, but separate from the form. Referenced instructions for forms are almost always in separate documents from the form itself, unless they are printed or contained in the form itself. There is no way to link the instructions to the blank in the form to be completed so that the sentence, paragraph, or line in the instructions is linked to the line in the form. The precise instructions as to how to complete the line in the form may be complete in the manual, reference book, or instructions and refer to the number or name of the blank line in the form to be completed, but they are only referenced, not linked. This is a problem in many situations. (FIG. 5.)

For example, the IRS 1040 is the form for individual taxpayers to complete to self-assess their taxes annually. Extremely summary instructions are printed on the IRS 1040 or provided on line. However, the more complete IRS Instructions to complete the IRS 1040 are published in paper in a separate booklet. Similarly, IRS “Publications” are separate from the IRS 1040 and the Instructions. On a computer from a CD or on-line, the Form 1040, Instructions for the 1040, and Publications that related to individual taxpayers are provided separately in paper form or in separate PDF files on the computer or on line. They are referenced in general terms or sometimes by sections or paragraph, but always involve a separate (usually PDF) file to be examined. On a computer there is no electronic linkage between the IRS Form 1040 and the PDF Instructions file to complete the Form 1040.

When the instructions are pursued for guidance as to how to fill in or complete an individual line on the IRS form 1040, the individual using them must search from the top of each page and in order of the pages in the instructions or online in sequential order until the relevant section or paragraph of the instructions are found. While topics are labeled, either alphabetically or in the order or the lines to be completed on the form, the search is visual or typically sequential in the case of a computer. That is, the relevant sentence or paragraph in the instructions may be mentioned in the form by number or subject, but it is only referenced, not linked. (FIG. 6.)

In the case of a computer using a CD or an on line 1040 computer program, the Instructions for the Form 1040 and other possibly relevant Publications are in separate PDF files. (See www.irs.gov).

Similar situations occur in life, health, and property casualty insurance claims forms that refer to instructions in a separate document, but do not link them to the line to be completed on the claims form. The instructions as to how to complete the form must be visually reviewed to find the appropriate sentence, paragraph, or section in the instructions for the line to be completed on the form.

In health care, the attending medical person has a form for information on the patient to complete. There are medical manuals available that instruct the medical person in completing each section or line or blank on the form, but these instructions are physically in a separate paper publication or separate computer file and must be searched by topic or number to reference the line on the form to be completed. Again, on the web, the instruction manuals are PDF files that are referred to in the form, but not linking the line in the form with the relevant sentence, paragraph, section, or chapter in the instructions. (See FIG. 7.)

On a global basis, each year government entities, private corporations, and non-profit organizations procure billions of dollars of good and services. The goods compromise all of the material purchased by entities. For example, in the United States Department of Defense, the purchase of equipment for war fighting is known as weapons systems acquisition, e.g. an airplane. Similarly, the purchase of jet fuel for the airplane is known as procurement. While this terminology is specific to the Department of Defense, in common English both of these would be referred to as procurements or purchases.

Procurements can cover tangible goods such as vehicles, buildings, and even large public projects such as constructing a dam are all procurements. Procurements also cover intangible items such as IT services, software, or professional advice, e.g. medical or legal advice. All of these are “acquired” or “obtained” by governments at all levels, public and private corporations, multilateral financial institutions, and non-profit organizations. For example, the World Bank has certain procurement guidelines to provide rules for its procurements. In the United States Government, OMB circular A-76 (May 29, 2003) that provides guidelines for the procurement of federal government goods and services. (See FIG. 17 for existing situation.)

Multilateral financial institutions like the World Bank and its affiliate the International Financial Corporation have major procurement challenges. Their mission is to loan to governments or the private sector, then to oversee the use of this money to procure goods and services in the country to support a program to promote economic development. This can range from procuring medical or educational services to computers, cars, or major infrastructure projects, e.g. a municipal water system. All of these involve procurement.

### SUMMARY OF THE INVENTION

In one embodiment, there is presented a method for integrating intelligence systems, comprising receiving a search query, searching, using the search query, a plurality of XBRL data fields in records in a plurality of different data repositories, with each of the XBRL data fields having metadata representing attributes at the data value level based on context data according to an information taxonomy, and with links formed between and/or among at least two items selected from one or more of the categories of data fields, metadata, and components associated with the data fields, the searching obtaining a search result, triggering the creation of an electronic agency communication of at least a partial version of the search result; and communicating the at least partial version of the search result, wherein the content or addressee of the electronic agency communication is determined, at least in part, by the value of an importance factor related to one or more data items returned in the search result.

In a further embodiment, the importance factor is part of the metadata of one of the data fields.

In a further embodiment, the importance factor is calculated based upon the data items returned in the search result.

In a further embodiment, the importance factor is calculated by an algorithm that utilizes the search result.

In a further embodiment, if the importance factor of one of the data items returned in the search result is marked as high, or its equivalent, the agency communication is composed with a warning indication.

In a further embodiment, if the importance factor of one of the data items returned in the search result is marked as high, or its equivalent, a second agency communication is composed to a high-level official in the agency.

In a further embodiment, the second agency communication is composed with a warning indication.

In a further embodiment, if the importance factor of one of the data items returned in the search result is marked as high, or its equivalent, multiple agency communications are composed.

In a further embodiment, at least one of the agency communications is marked with a warning indication.

In a further embodiment, the agency communications are communicated to a plurality of different agencies.

In a further embodiment, the search query comprises one or more of a time, a date, a nationality, a mode of transportation, a person's name, a person's regional affiliation, a location, and a transported item.

In a further embodiment, at least one item in the search result has a communication restriction data linked thereto, and includes a designation of the at least one item and an explanation or a link to an explanation of the legal communication restriction data.

In a further embodiment, display data for the designation for the at least one item includes a link to initiate a request for permission to disclose the at least one item.

In a further embodiment, at least one item in the search result has a communication restriction data linked thereto, and a request for permission to disclose the at least one item is automatically initiated.

In a further embodiment, the search query comprises one or more of a person's name, a person's regional affiliation, a date, a location, a mode of transportation, and a transported item.

In a further embodiment, the search query is based on a convergence algorithm and searches for XBRL data fields with metadata relating to a period of time, a geographic location, and/or a mode of transportation.

In a further embodiment, the method comprises performing a convergence algorithm on items in the search result.

In a further embodiment, the method comprises utilizing the search result in an analytical model.

In a further embodiment, the search query is automatically generated.

In a further embodiment, one or more of plurality of different data repositories contains government entity XBRL databases.

In a second embodiment, there is presented a method for integrating intelligence systems, comprising receiving a search query, searching, using the search query, a plurality of XBRL data fields in records in a plurality of different data repositories, with each of the XBRL data fields having metadata representing attributes at the data value level based on context data according to an information taxonomy, and with links formed between and/or among at least two items selected from one or more of the categories of data fields, metadata and components associated with the data fields, the searching obtaining a search result, composing an electronic agency communication of at least a partial version of the search result, and communicating the at least partial version of the search result, wherein one or more of plurality of different data repositories contains government entity XBRL databases.

In a further embodiment, the metadata associated with the data field represents one or more of a time, a date, a nationality, a mode of transportation, a person's name, a person's regional affiliation, a location, and a transported item.

In a further embodiment, at least one item in the search result has a communication restriction data linked thereto, and includes a designation of the at least one item and an explanation or a link to an explanation of the legal communication restriction data.

In a further embodiment, the display data for the designation for the at least one item includes a link to initiate a request for permission to disclose the at least one item.

In a further embodiment, at least one item in the search result has a communication restriction data linked thereto, and a request for permission to disclose the at least one item is automatically initiated.

In a further embodiment, the search query comprises one or more of a person's name, a person's regional affiliation, a date, a location, a mode of transportation, and a transported item.

In a third embodiment, there is presented a program product for integrating intelligence systems, comprising one or more computer usable media having computer readable program code embodied therein or among them, to be executed by a computer, the computer readable program code comprising program code for receiving a search query, program code for searching, using the search query, a plurality of XBRL data fields in records in a plurality of different data repositories, with each of the XBRL data fields having metadata representing attributes at the data value level based on context data according to an information taxonomy, and with links formed between and/or among at least two items selected from one or more of the categories of data fields, metadata, and components associated with the data fields, the searching obtaining a search result, program code for triggering the creation of an electronic agency communication of at least a partial version of the search result, and program code for communicating the at least partial version of the search result, wherein the content or addressee of the electronic agency communication is determined, at least in part, by the value of an importance factor related to one or more data items returned in the search result.

In a fourth embodiment, there is presented a system for integrating intelligence systems, comprising a data repository, and one or more processors operably connected to the data repository for implementing the following components: a component for receiving a search query, a component for searching, using the search query, a plurality of XBRL data fields in records in a plurality of different data repositories, with each of the XBRL data fields having metadata representing attributes at the data value level based on context data according to an information taxonomy, and with links formed between and/or among at least two items selected from one or more of the categories of data fields, metadata, and components associated with the data fields, the searching obtaining a search result, a component for triggering the creation of an electronic agency communications of at least a partial version of the search result, and a component for communicating the at least partial version of the search result, wherein the content or addressee of the electronic agency communication is determined, at least in part, by the value of an importance factor related to one or more data items returned in the search result.

In a fifth embodiment, there is presented a method for displaying one or more forms, comprising maintaining or providing a plurality of XBRL electronic forms in one or more data repositories, each of the forms comprising a plurality of XBRL data fields having metadata and components associated with the data fields according to a form taxonomy, each of a plurality of the XBRL data fields in one of the electronic forms being linked to at least one XBRL data field or metadata in one or more other of the XBRL electronic forms, and to at least one item of explanation data relating to completing the form, upon receiving a command relating to one of the XBRL data fields in one of the electronic forms, displaying a menu of one or more XBRL data fields in the one or more other forms and at least one item of explanation data, receiving a selection of one of the one or more XBRL data fields or the item of explanation in the menu, and displaying a value in the selected XBRL data field or displaying the item of explanation.

In a further embodiment, the method comprises determining if a criterion has been met for display of one or more potential items that may be displayed in the menu, wherein the displaying a menu step comprises determining which items to display in the menu based on whether the criterion has been met.

In a further embodiment, the method comprises determining if more than one potential item for display exists, and ranking the items for display.

In a further embodiment, the ranking may be done by the most often used instruction.

In a further embodiment, the ranking may be done alphabetically.

In a further embodiment, the ranking may be done by a predetermined sequence that permits the display of a number of the items for selection.

In a further embodiment, one or more other forms are tax forms.

In a further embodiment, the tax forms are prior year tax forms.

In a further embodiment, the tax forms are state tax forms.

In a further embodiment, the one or more other forms are medical forms.

In a further embodiment, medical research can be displayed in relation to the data input to the one or more forms.

In a further embodiment, the menu may contain one or more links.

In a further embodiment, the forms are for obtaining a license or permit.

In a further embodiment, the forms are for a government agency.

In a further embodiment, the government agency is the Internal Revenue Service.

In a sixth embodiment, there is presented a program product for displaying one or more forms, comprising one or more computer usable media having computer readable program code embodied therein or among them, to be executed by a computer, the computer readable program code comprising program code for maintaining or providing a plurality of XBRL electronic forms in one or more data repositories, each of the forms comprising a plurality of XBRL data fields having metadata and components associated with the data fields according to a form taxonomy, each of a plurality of the XBRL data fields in one of the XBRL electronic forms being linked to at least one XBRL data field or metadata in one or more other of the electronic forms, and to at least one item of explanation data relating to completing the form, program code for, upon receiving a command relating to one of the XBRL data fields in one of the electronic forms, displaying a menu of one or more XBRL data fields in the one or more other forms and at least one item of explanation data, program code for receiving a selection of one of the one or more XBRL data fields or the item of explanation in the menu, and program code for displaying a value in the selected XBRL data field or displaying the item of explanation.

In a seventh embodiment, there is presented a system for displaying one or more forms, comprising a data repository, and one or more processors operably connected to the data repository for implementing the following components: a component for maintaining or providing a plurality of XBRL electronic forms in one or more data repositories, each of the forms comprising a plurality of XBRL data fields having metadata and components associated with the data fields according to a form taxonomy, each of a plurality of the XBRL data fields in one of the XBRL electronic forms being linked to at least one XBRL data field or metadata in one or more other of the electronic forms, and to at least one item of explanation data relating to completing the form, a component for, upon receiving a command relating to one of the XBRL data fields in one of the electronic forms, displaying a menu of one or more XBRL data fields in the one or more other forms and at least one item of explanation data, a component for receiving a selection of one of the one or more XBRL data fields or the item of explanation in the menu, and a component for displaying a value in the selected XBRL data field or displaying the item of explanation.

In an eighth embodiment, there is presented a method for facilitating procurement, comprising generating an XBRL procurement request electronic document comprising a plurality of XBRL data fields, with each of a plurality of data fields having associated components representing attributes at the data value level in the data field based on a taxonomy, and forming links between and/or among at least two items selected from one or more of the categories of the data fields, metadata and components associated with the data fields in the XBRL procurement request electronic document, receiving a plurality of vendor submission electronic documents, with each vendor submission electronic document comprising a plurality of the XBRL data fields completed with one or more vendor data field values, extracting vendor data field values for a plurality of the XBRL data fields in a plurality of the vendor submission electronic documents, generating comparison data for the extracted vendor data field values for a plurality of the XBRL data fields, and electronically communicating the comparison data.

In a further embodiment, the taxonomy is a general ledger taxonomy.

In a further embodiment, the XBRL procurement request electronic document includes an XBRL buyer data field value for a plurality of the XBRL data fields, with the method further comprising determining a variance, if any, between a plurality of the vendor data field values and the respective XBRL buyer data field values for those data fields, and electronically communicating this variance for the plurality of the vendor data field values.

In a further embodiment, the method comprises ranking a plurality of the vendor submission electronic documents based on the variances determined for a plurality of the data fields.

In a further embodiment, the method comprises electronically communicating a contract award notice to a submitting vendor for one of the vendor submission electronic documents.

In an ninth embodiment, there is presented a program product for facilitating procurement, comprising one or more computer usable media having computer readable program code embodied therein or among them, to be executed by a computer, the computer readable program code comprising program code for generating an XBRL procurement request electronic document comprising a plurality of XBRL data fields, with each of a plurality of data fields having associated components representing attributes at the data value level in the data field based on a taxonomy, and forming links between and/or among at least two items selected from one or more of the categories of the data fields, metadata and components associated with the data fields in the XBRL procurement request electronic document, program code for receiving a plurality of vendor submission electronic documents, with each vendor submission electronic document comprising a plurality of the XBRL data fields completed with one or more vendor data field values, program code for extracting vendor data field values for a plurality of the XBRL data fields in a plurality of the vendor submission electronic documents, program code for generating comparison data for the extracted vendor data field values for a plurality of the XBRL data fields, and program code for electronically communicating the comparison data.

In an tenth embodiment, there is presented a system for facilitating procurement, comprising a data repository, and one or more processors operably connected to the data repository for implementing the following components: a component for generating an XBRL procurement request electronic document comprising a plurality of XBRL data fields, with each of a plurality of data fields having associated components representing attributes at the data value level in the data field based on a taxonomy, and forming links between and/or among at least two items selected from one or more of the categories of the data fields, metadata and components associated with the data fields in the XBRL procurement request electronic document, a component for receiving a plurality of vendor submission electronic documents, with each vendor submission electronic document comprising a plurality of the XBRL data fields completed with one or more vendor data field values, a component for extracting vendor data field values for a plurality of the XBRL data fields in a plurality of the vendor submission electronic documents, a component for generating comparison data for the extracted vendor data field values for a plurality of the XBRL data fields, and a component for electronically communicating the comparison data.

### BRIEF DESCRIPTION OF THE DRAWINGS

FIG. 1 is a schematic block diagram of the prior art in the law enforcement field.

FIG. 2 is a schematic block diagram of an embodiment in the law enforcement field.

FIG. 3 is a schematic block diagram of an embodiment in the law enforcement field.

FIG. 4 is a schematic block diagram of an embodiment in the law enforcement field.

FIG. 5 is a schematic block diagram illustrating the prior art.

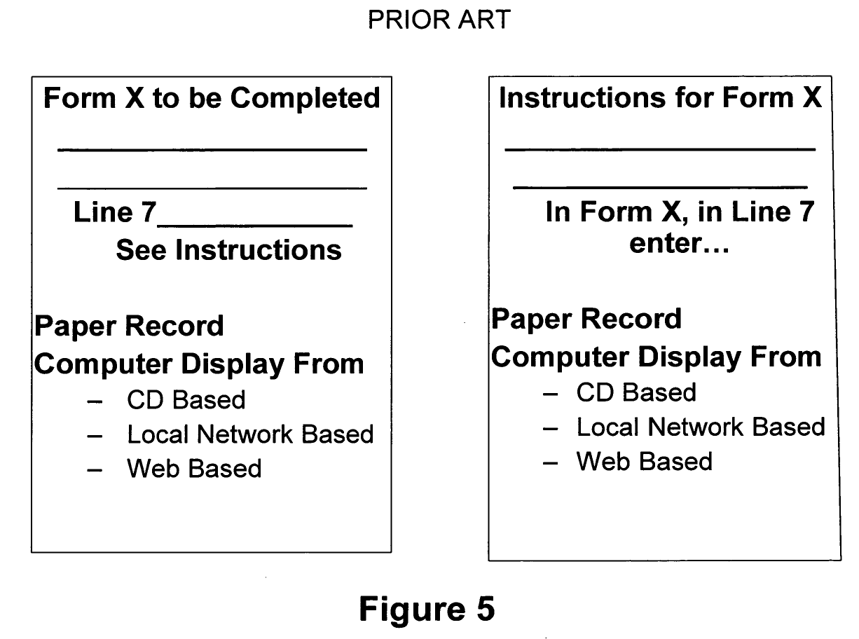

FIG. 6 is a schematic block diagram illustrating the prior art.

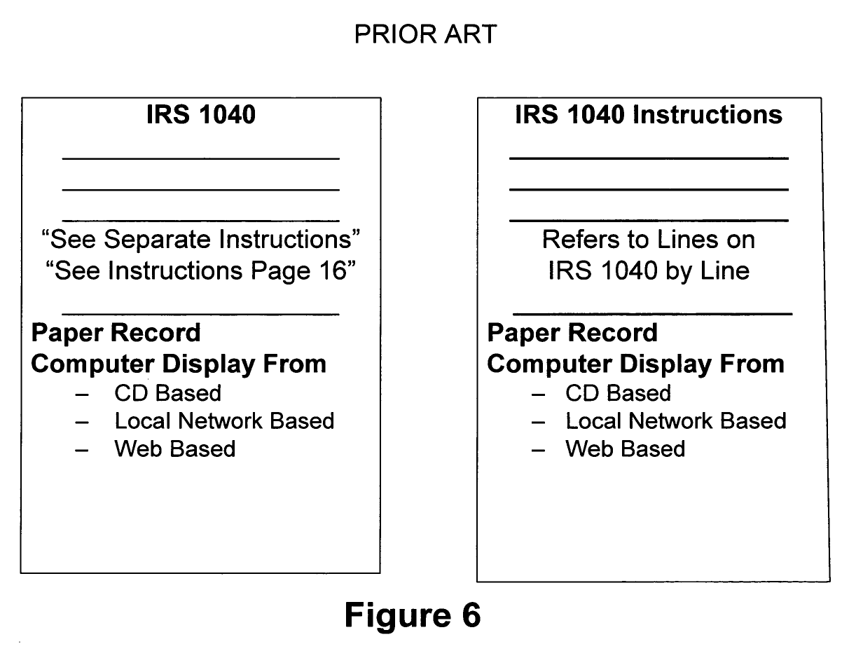

FIG. 7 is a schematic block diagram illustrating the prior art.

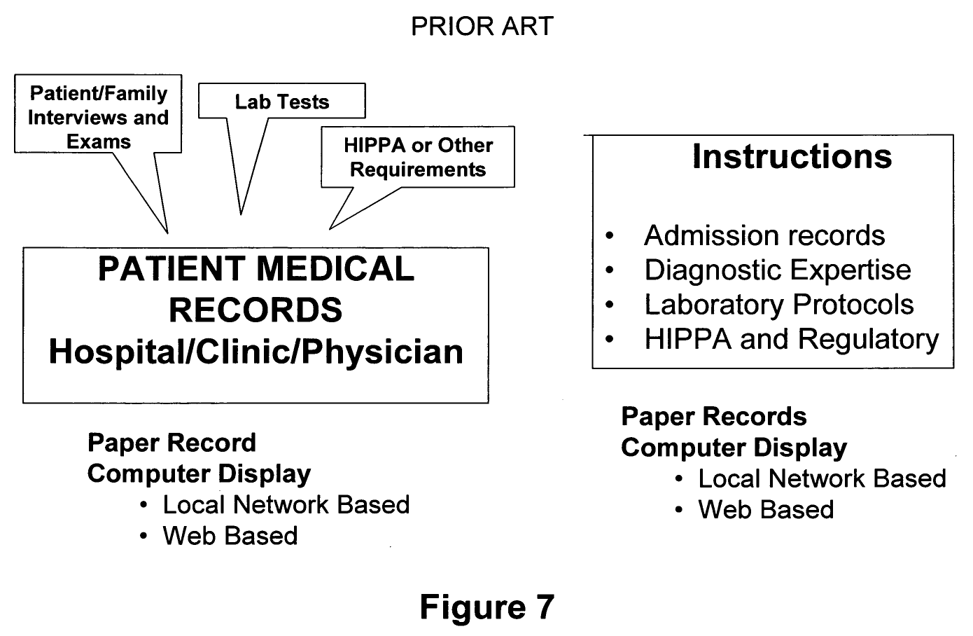

FIG. 8 is a schematic block diagram of one embodiment of the forms invention.

FIG. 9 is a schematic block diagram of one embodiment of the forms invention.

FIG. 10 is a schematic block diagram of one embodiment of the forms invention.

FIG. 11 is a schematic block diagram of one embodiment of the forms invention.

FIG. 12 is a schematic block diagram of one embodiment of the forms invention.

FIG. 13 is a schematic block diagram of one embodiment of the forms invention.

FIG. 14 is a schematic block diagram of one embodiment of the forms invention.

FIG. 15 is a schematic block diagram of one embodiment of the forms invention.

FIG. 16 is a schematic block diagram of one embodiment of the forms invention

FIG. 17 is a schematic block diagram of prior art in the procurement field.

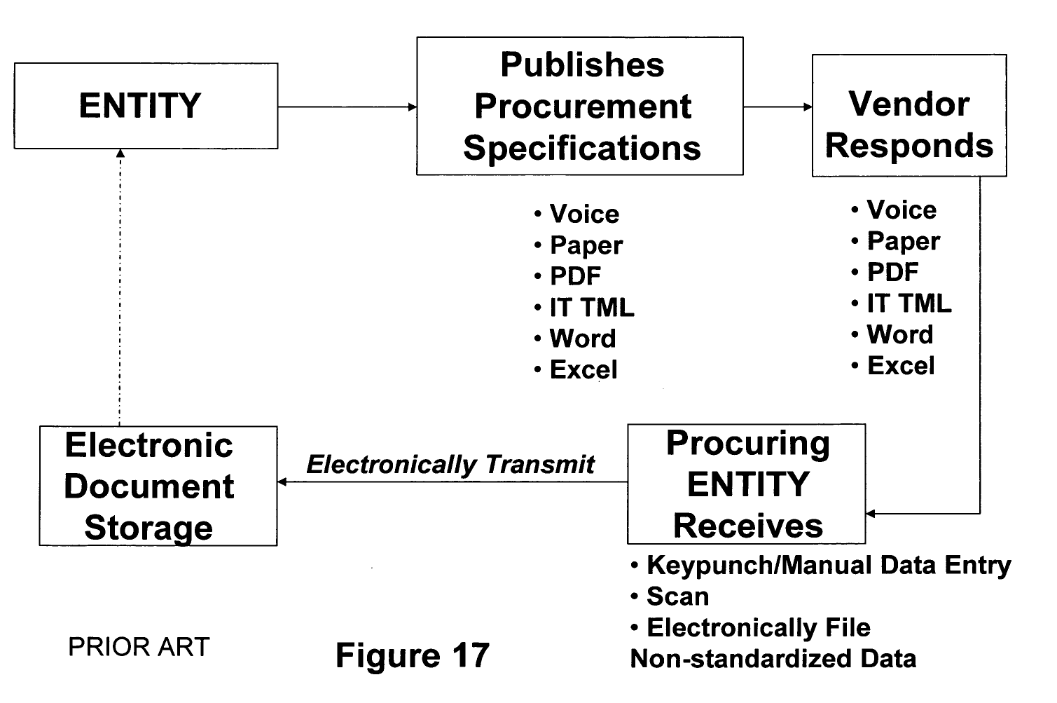

FIG. 18 is a schematic block diagram of a first embodiment of a procurement invention.

FIG. 19 is a schematic block diagram of a first embodiment of a procurement invention.

FIG. 20 is a schematic block diagram of a first embodiment of a procurement invention.

### DETAILED DESCRIPTION OF THE PREFERRED EMBODIMENTS

The invention is web-based XBRL enhanced XML application software that is interoperable between multiple computer systems or repositories that may include distributed data bases and provides them functionality that they do not have without being interoperable. Utilizing the XML/XBRL interoperability feature, the application software is designed in one embodiment, to serve as middle-ware between different computer systems.

It should be noted that the term “XBRL” for purposes of this application, is given a special definition that encompasses not only XBRL, but also extensible Mark-up language equivalents that associate components representing attributes at the value level in a data field based on an information taxonomy, wherein a link or links are formed between and/or among at least two items selected from one or more of the categories of data fields, metadata, and components associated with the data fields, e.g., between two data field items, or between two metadata items, or between two component items, or between a data field item and an item of metadata, or between a data field item and a component item, or among both data fields and attributes. By way of example, attributes at the value level might relate to what the value represents, e.g., a “item of interest”, a current location point in time when location of “item of interest” was known, e.g., 4 pm in the afternoon, date when location of “item of interest” was known, e.g., Feb. 2, 2006, person(s) or organization(s) in control of “item of interest”, and so forth.

XBRL provides metadata about each specific data field and content contained within a document by utilizing XBRL components. Thus XBRL enables components to be applied by data field at the most granular level. as opposed to enabling components to be applied at the document level with XML. XBRL can be implemented to be a standards-based vendor-independent technology.

XBRL files are defined by Metadata set out in Taxonomies. Taxonomies capture the definition of individual reporting elements as well as the relationships between elements within taxonomy and in other taxonomies. Taxonomies are a collection of XML schema documents. Subsequent extensions or adjustments to the taxonomies may be standardized. An XBRL component includes the resources necessary to implement a taxonomy for a data field, such as metadata, elements, tuples, linkbases, and stylesheets, to name a few. Schema defines items (data) and Tuples (concepts). Linkbases are a collection of links that arc concepts to resources. Style Sheets contain a page's semantic content and structure. For example, an XBRL Style Sheet relates to the rendering of text and data for communication. The Instance Document holds business facts, contexts, units, and references. For example, an individual's completed 1040 is like an XBRL Instance Document. Selected links would also be formed between and among the data fields and/or between and among metadata for the different data fields, and/or between and among each component (elements, tuples, metadata, and other resources) of the XBRL information taxonomy. These links could be formed by an XBRL conversion engine or at a later time by means of a subsequent linking operation or program.

A taxonomy for law enforcement or intelligence data could be implemented, for example, by multiple government agencies or a consortium of experts designing a taxonomy for the values or ranges of values that would be measured for a given data field. The taxonomy developers would typically also build in a plurality of conformance tests on each data item to insure that each data item entered/matched into a data field was within its appropriate data field parameter location. These conformance test would comprise the application of one or more business rules to specify what data could go into a data field and not accepting anything that does not meet these one or more rules. For example, if the data field is supposed to contain information regarding the date that the location of an “item of interest” was known in mm/dd/yyyy format, then the XBRL software will test and validate the incoming data to be sure the key punch operator or another data stream isn't entering a currency value in “dollars”.

Further, XBRL allows a robust method of expressing semantic meanings for its data fields, and the relationships between those data fields. This semantic meaning can be expressed by calculations to handle summations, formulas utilizing different data fields, and may also be obtained by a definition linkbase. Thus, another conformance test could include whether the data fields A, B and C, when utilized in a calculation such as A=B+C, give the appropriate results. Thus, data is not just tested to ensure it meets specific formats, but also to ensure that the context of the data, both as a single data item and in relation to other data items, is correct as well.

Because it is the only data standard designed to work with all operating and application software, XBRL can tie together the existing legacy systems in any and all law enforcement agencies. In many embodiments, no existing software need be replaced with new software just to obtain interoperability. All legacy software is mapped to work together using XBRL as a link or connector. In embodiments of the invention, an XBRL file is used to access data and metadata within an XBRL file and subject it to operations such as addition, subtraction, division, multiplication, or comparison with other data by a computer. This means that data from various databases, in differing formats, is now understandable to the computer and can be managed on the computer.

Using the present system, in one embodiment, data from multiple databases in differing formats can be accessed and analyzed. This is in contrast to a file pertaining to a “person of interest” in XML, which is essentially a picture of the printed page designed to be viewed by humans, where the data contained in the file is inactive. That inactive data must be extracted, transferred, and entered into a new computer program. In the present system, XBRL software can monitor changes in data field values within the XBRL information record within the record's data field without removing it from the XML file. It is “Interactive.”

An exemplary system for implementing the overall system or portions of the invention include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Additionally, embodiments within the scope of the present invention include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed or received by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention will be described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

It can be understood that the data being dealt with may be privileged information, and thus methods to secure the communication of data will be utilized. Specifically, encryption methods that are well-known in the art may be utilized in accordance with the invention to securely transfer data across logical connections to remote computers.

XBRL is interoperable with all known operating systems. It also operates with all application software's identified to date. The amount of systems work needed depends on the agency's proprietary or legacy systems. Some information systems will take relatively little work to convert; others will be enormously expensive and difficult computer systems integrations work to convert to XBRL.

The invention, in one embodiment, is related specifically to an XBRL law enforcement management system. The system can contain a plurality of data repositories, which may be distributed. These repositories includes a plurality of XBRL data bases and XML data bases that hold XBRL documents and other documents that could be converted into XBRL documents. Along with a plurality of data bases, these repositories are able to store the XBRL taxonomies and all of the components associated with the XBRL documents and data fields. One or more of these data repositories may store government entity XBRL data bases, associated with different law enforcement agencies and intelligence agencies at the local, state, and federal levels, and may include private data bases. These XBRL data bases hold XBRL records with a plurality of XBRL data fields, with each data field having metadata and components that represents attributes at the data field value level. XBRL operates at the data level for alpha and numeric characters, with metadata related to the data field value level based on data according to an information taxonomy. The metadata may include all information pertinent to those data fields utilized in law enforcement agency databases.

As mentioned above, information from various sources, in various forms, will be mapped into XBRL data records, with one or more XBRL data fields in each XBRL record. Based on the data relating to the XBRL data fields and the values in those fields, metadata will be created representing attributes at the data field level based on an information taxonomy and associating the metadata with the data field. The term “associating” is intended to encompass the act of electronically linking.

This conversion into an XBRL or equivalent data record is accomplished by a conversion engine, which operates to take each of a plurality of items of data from a data record and map it or otherwise electronically transfer it into a data field or fields in the XBRL data record and validate the data against an information taxonomy. The conversion engine further converts context data and other data associated with the data value into metadata. For example, for a field of person with value “John Doe”, there would be associated with that value in the data field a plurality of metadata identifying a given location, address, nationality, regional affiliation, to name a few. In one embodiment, the conversion engine could also form selected links between and/or among the data fields and/or between and among metadata for the different data fields, and/or between and among each component (elements, tuples, metadata, and other resources) of the XBRL information taxonomy. Alternatively, these links could be formed at a later time by means of a linking program.

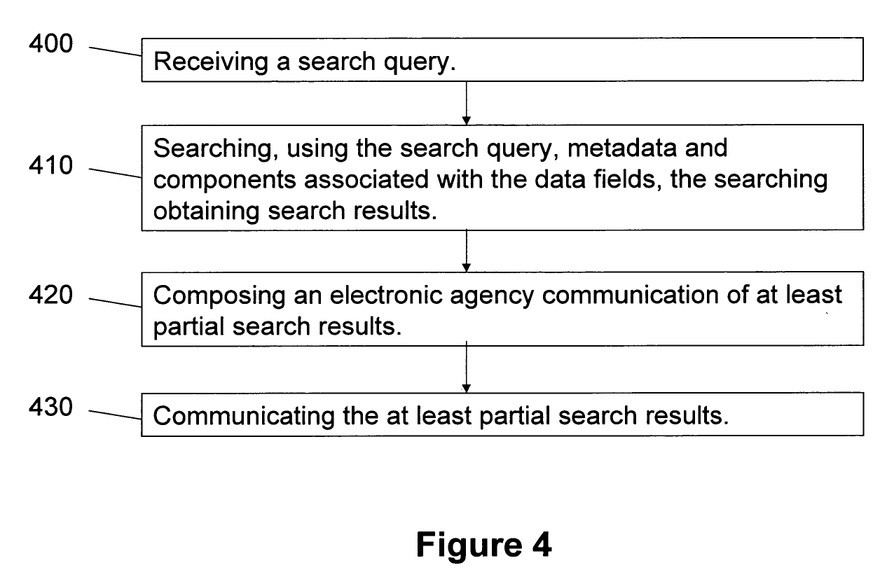

The XBRL law enforcement management system enables law enforcement officials to use a computer to search for identical or related terms in multiple data bases, identify the related terms, create a new record of words, data, or phrases and electronically transmit that record to a remote computer system where it can be visually displayed or printed out for a hard copy record. Ensuring that there is full interoperability of the information and data files at the individual alpha and numeric data fields of different law enforcement and intelligence agencies means that a Boolean search on an individual word or number by a member or group of members of any involved agency or agencies is comprehensive and has a much higher probability of in fact, connecting the dots in terms of intelligence information. The XBRL law enforcement system operates as middle-ware that is system integrated with existing law enforcement or intelligence computer systems to provide enhanced Boolean search capabilities from the agency's databases and repositories. (FIG. 4)

Referring now to FIG. 4, there is illustrated one embodiment of an XBRL law enforcement system. Block 400 comprises an operation of receiving a search query. In one embodiment, the query may be on a data item. Various law enforcement agencies at all levels (local, state, and federal), as well as various intelligence agencies, often track specific “people of interest”, “items of interest”, or a confluence of events at one or more locations.

In one embodiment of this operation, a law enforcement official may want to track shipping invoices, freight forwarding information, ships cargo manifest, ships crew manifest, and existing data bases of known “persons of interest” or “items of interest” that are being moved by airplane, ship, or truck between international departure points and termination points. In this embodiment, the search query may comprise a person's name, regional affiliation, dates, locations, modes of transportation, and transported items. The query terms utilized or available in creating a search query is not limiting on the invention.

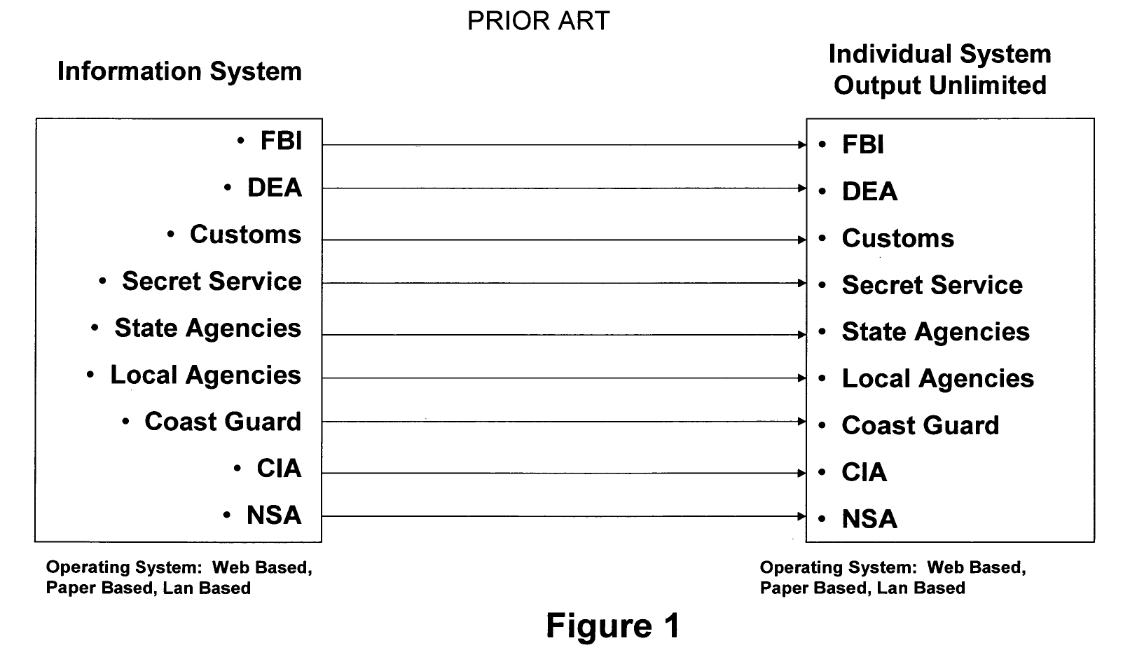

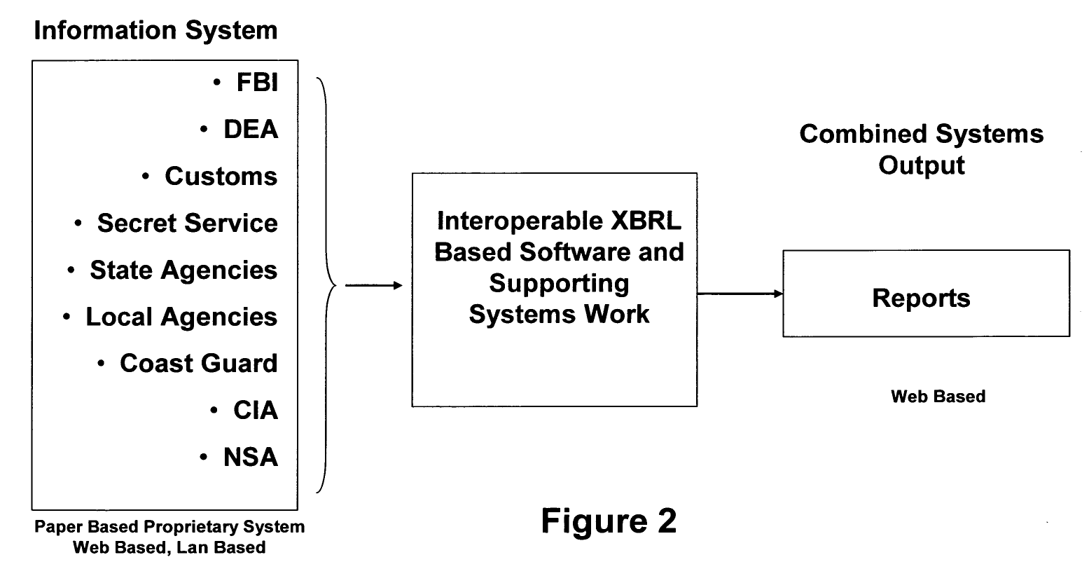

In another embodiment, the search query could be based upon a convergence algorithm that utilizes XBRL data fields. Various law enforcement and intelligence agencies at the local, state and federal levels often share information such as agent interview reports, case memoranda, and analytical diagnosis. These agencies can also compare this information by individual “person of interest” or “items of interest” with all other information on the same date, subject matter, or geographic locale. Further, this information can be electronically compared to all law enforcement computer databases, such as those utilized by the FBI, Customs Service, Drug Enforcement Agency, Coast Guard, CIA, Secret Service, and state and local law enforcement agencies. (FIG. 2) In the prior art, this information would only be available to the agency maintaining the database. For example, the FBI would only be able to access and search the FBI database. (FIG. 1 illustrates this limitation of the prior art.) The usage and types of different law enforcement computer databases is not limiting on the invention. Thus, a convergence algorithm is used as a search query to obtain this data.

A third embodiment expands the search query based on a convergence algorithm, utilizing the searches for XBRL data fields along with metadata relating to a period of time, geographic location, names, modes of transportation, items, to name a few. The metadata utilized or available with the XBRL data fields is not limiting on the invention. The need for this type of query arises because the case management and intelligence reports from various law enforcement agencies can be electronically screened to identify similar dates, locations, names, items, and so forth, from different agencies, and compare them against a pre-determined selected items (name, date, place, or location).

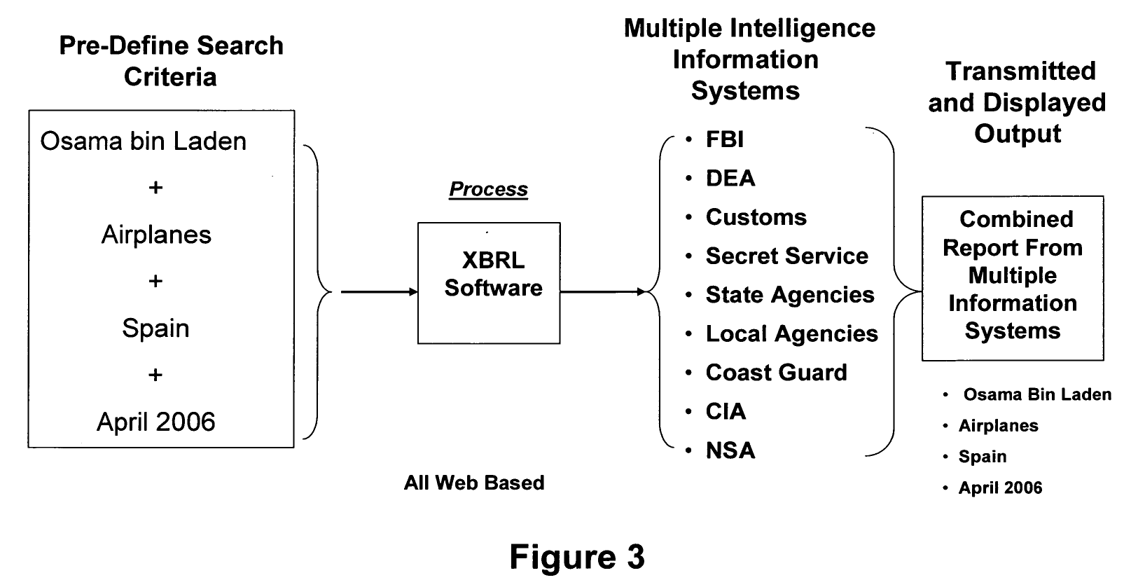

The criteria for the search and display will be specified and may be against previously established criteria or criteria that are set for a particular search, e.g. “Osama bin Laden+airplanes+Spain+March, 2006.” In this example, the software would search many law enforcement agencies databases and extract the four criteria “Osama bin Laden” “Airplanes” “Spain” and “March 2006” from any data base and relate it to the other search criteria. This requires the computer to match any one item with all other items to see if they meet two, three or all four criteria for the search. (FIG. 3)

In another embodiment, a search may be automatically triggered by a change or inclusion of data into one of the XBRL repositories. In this case, a search query would be automatically generated in response to the change or inclusion of data. For example, if a police report is filed against a person, then a search query pertaining to that person may be automatically initiated. Other examples of automatic initiation of a search, and the automatic generation of a search query, may occur during or after the purchase of weapons (such as guns or swords), complaints to private or public law enforcement agencies, and threats received against institutions or buildings (such as bomb threats), to name a few.

Block 410 comprises an operation of searching the repository, using the search query, and obtaining a search result. This search can be carried out, in one embodiment using one or more search engines or data wizards, on a plurality of XBRL data fields in records with each of the XBRL data fields linking or having metadata that can potentially link to one or more data fields in another database or to components associated with the data field, or to legal communication restriction data. The metadata associated with a data field can include time, data, nationality, mode of transportation, name, regional affiliation, location, transported item, and so forth. The metadata utilized or available with the XBRL data fields is not limiting on the invention. The criteria for the search and display will be specified and may be against previously established criteria or criteria that are set for a particular search, e.g. “Osama bin Laden+airplanes+Spain+March, 2006.”

In one embodiment, the search result may be input into an analytical model. For example, a convergence algorithm may be performed on the search result. For example, if law enforcement officials are searching for information on two separate terrorist attacks, and the pattern of facts for each seems similar, a convergence algorithm may be run on the information obtained in the search results pertaining to both searches. This may provide further information or links between the two attacks that may not have been otherwise discovered. As another example, law enforcement officials may obtain a search result pertaining to all terrorist attacks in a set time period, and then run a convergence algorithm on the obtained search result to find commonalities between the attacks. This may reveal vulnerabilities in various areas of national security that may be exposed or problem areas in national security that should be addressed. Further, it may show local or statewide areas of strength or preparedness that should be emulated on a national level. In one embodiment, a convergence algorithm may be performed before an agency communication is composed. In another embodiment, a convergence algorithm may be performed after an agency communication is displayed.

Block 420 comprises an operation of composing an electronic agency communication of the search result, or at least a partial version of the search result. In one embodiment, the search results may be input into a standard or existing template to create a communication specific to the agency. In another embodiment, the search result may be utilized in a standard, interoperable XBRL format for communication to the agency, such that the communication can be read by any remote machine. The communication may also retain and/or include the original incoming records in electronic form. Accordingly, the XBRL or equivalent data record may also include the original data including pictures and graphics in electronic form, for example as an attachment. Alternatively, the XBRL or equivalent data record may include one or more electronic links to the original records in one or more other electronic databases or repositories. Thus, the communication operation may include these records as an attachment, or may include links to the one or more original data records. The mode of composing is not limiting on the invention.

In one embodiment, legal communication restriction data may be linked to the search result, or one or more items from the search result. This legal communication restriction data restricts who has permission to view or disclose the search result or specific data from the search result or may limit disclosure to within a given agency. The legal communication restriction data may designate the search result, or one or several items from the search result, as being restricted, with an explanation or a link to an explanation as to why the data is linked with the legal communication restriction data. In one embodiment, the display data for this designation of data may include a link to initiate a request for permission to disclose the restricted data item or items. In another embodiment, when a data item or data items are linked to legal communication restriction data, there may be an automatic initiation of a request for permission to disclose the linked data item or items.

In another embodiment, the search terms in the search query may be associated with field values that have an importance factor as part of the metadata of the field. The value of this importance factor can affect the urgency with which search results are treated. For example, if a query is carried out, and the result indicates that one of the data items that is returned has an importance factor with a value that indicates it is of high importance, either in conjunction with other items, or on its own, then enhanced communication is triggered. In one embodiment, the agency communication being composed in this situation may include an alert, or some form of a warning indication, such as the word “Urgent” in bold red letters. In another embodiment, a second agency communication may be composed if a threshold importance level is exceeded, to a higher, or highest, level official in the agency, informing them of the marked search results. In another embodiment, multiple agency communications may be composed to various high-level officials in one agency or to more than one agency that may have jurisdiction over the tagged items involved in the search results. Alerts, such as those utilized in the first embodiment, may be utilized in any of the further embodiments included above, and are not limiting on the invention.

In another embodiment, the search terms in the search query may be associated with field values that have an importance factor as part of the metadata of the field. Semantic relationships between different search terms may affect the type of communication of the search results that is appropriate. Because XBRL supports the verification of semantic relationships between data items, the importance factor may be the product of a relationship of multiple data items. Specifically, the importance factor of a data item returned in a search results may depend upon whether other specific data items were returned in the search result. The information taxonomy will support predefined relationships between data items, such that the importance factor for these data items is determined by which items are present in the search result. For example, if a person of interest had a police complaint filed in his name, that may not trigger enhanced communication of the search result. However, if data items are returned that indicate that the person of interest not only has a police report, but has also recently bought or applied to purchase a gun, the importance factor of these data items may be increased to a high value. If a query is carried out, and the result indicates that one or more data items that are returned have an importance factor with a value that indicates it is of high importance, then enhanced communication is triggered.

In another embodiment, the search result may be input into an algorithm that calculates an importance factor relating to one or more data items returned in the search result. Based upon this importance factor, enhanced communication may be triggered.

This enhanced communication can take place in many forms, similar to those shown above. In one embodiment, the agency communication may be composed with an alert, or some form of a warning indication, such as the word “Urgent” in bold red letters. In another embodiment, a second agency communication may be composed to a higher, or highest, level official in the agency, informing them of the marked search results. In another embodiment, any of multiple agency communications may be composed to various high-level officials in one agency or to more than one agency that may have jurisdiction over the tagged items involved in the search results. Alerts, such as those utilized in the first embodiment, may be utilized in any of the further embodiments included above, and are not limiting on the invention.

If the importance factor does not trigger enhanced communication, the search result may be communicated in a normal fashion to a person who requested the search query, or to a pre-specified logical or physical location (such as a physical address, email address, or server location, to name a few.) Thus, as shown above, the content and addressees of electronic agency communication(s) are determined, at least in part, by the value of the importance factor (or any equivalent thereof) related to one or more data items returned in the search result.

Block 430 comprises an operation of communicating the search results, or at least a part of the search results. The communication operation may be implemented by a presentation on a video display on any convenient electronic device, or via a communication of a text message, or a paper printout, or a printing or communication of a barcode, or via an email, or via a network communication, or a Web service, or an RFID tag, or any other mode of communication. The mode of communication is not limiting on the invention. In one embodiment, the communication may be made to video screen in one or more involved agencies or an office in an agency. In another embodiment, the communication may be a network communication to an electronic database at one or more involved agencies.

A further embodiment relating to forms is web-based XBRL enhanced XML application software that is interoperable between multiple computer systems or repositories that may include distributed data bases and provides them functionality that they do not have without being interoperable. Utilizing the XML/XBRL interoperability feature, the application software is designed to serve as middle-ware between different computer systems.

A taxonomy for form data could be implemented, for example, by multiple government agencies or a consortium of experts designing a taxonomy for the values or ranges of values that would be measured for a given data field. The taxonomy developers would typically also build in a plurality of conformance tests on each data item to insure that each data item entered/matched into a data field was within its appropriate data field parameter location. These conformance test would comprise the application of one or more business rules to specify what data could go into a data field and not accepting any data that does not meet one or more rules. As mentioned above, data is tested to ensure it meets specific formats, and also to ensure that the context of the data, both as a single data item and in relation to other data items, is correct as well.

Using the present system, in one embodiment, data from multiple databases in differing formats can be accessed and analyzed, and the content of a form can contain links to other forms and data from multiple databases. This is in contrast to a file, for example, pertaining to a IRS Tax Form 1040 in XML, which is essentially a picture of the printed page designed to be viewed by humans, where the data contained in the file is inactive. That inactive data must be extracted, transferred, and entered into a new computer program. In the present system, XBRL software can monitor changes in data field values and link to explanations or data from other sources that are related to the data field within the XBRL information record within the record's data field without removing it from the XML file. It is “Interactive.”

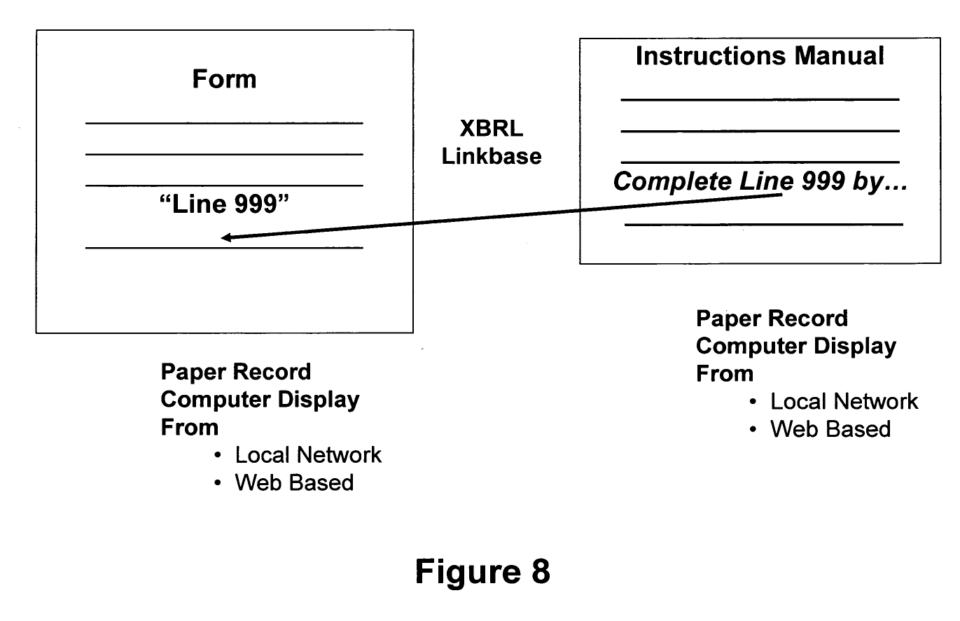

Specifically, another embodiment comprises web-based Extensible Markup Language (“XML”) software enhanced with the Extensible Business Reporting Language (“XBRL”) software that electronically links an individual line in a form to be completed with the relevant instruction for that line so that the instructions are one click away and displayed on a computer monitor. Utilizing the XML/XBRL linkbase feature, over the web, software will automatically link the line or the blank in the form to be completed with the correct instructions from the manual or guide as to how to complete that line in the form. (FIG. 8)

With one click of a mouse, the person completing the form will be able to read the relevant portion of the instructions manual for that line in of the form, which eliminates time consuming visual searching and the possibilities of error in the process, including the high probability of not finding the correct instruction (for the line in the form to be completed) in the manual or guide or searching numerous sections alphabetically or numerically until the correct instruction is found. This saves time and increases accuracy when using application software using the XML/XBRL linkbase feature on the web.

The electronic linking on the web ensures that the user is seeing the correct instructions for the blank line in the form that must be completed. By linking them electronically, it eliminates both user trying to identify what instructions they want to read, and ensures that the user does not go to the wrong portion of the instructions thereby increasing the probability of not ever finding the relevant instruction or having to scroll through all of the available instructions to identify the precise or relevant instructions needed for the individual line on the form the user needs to complete.

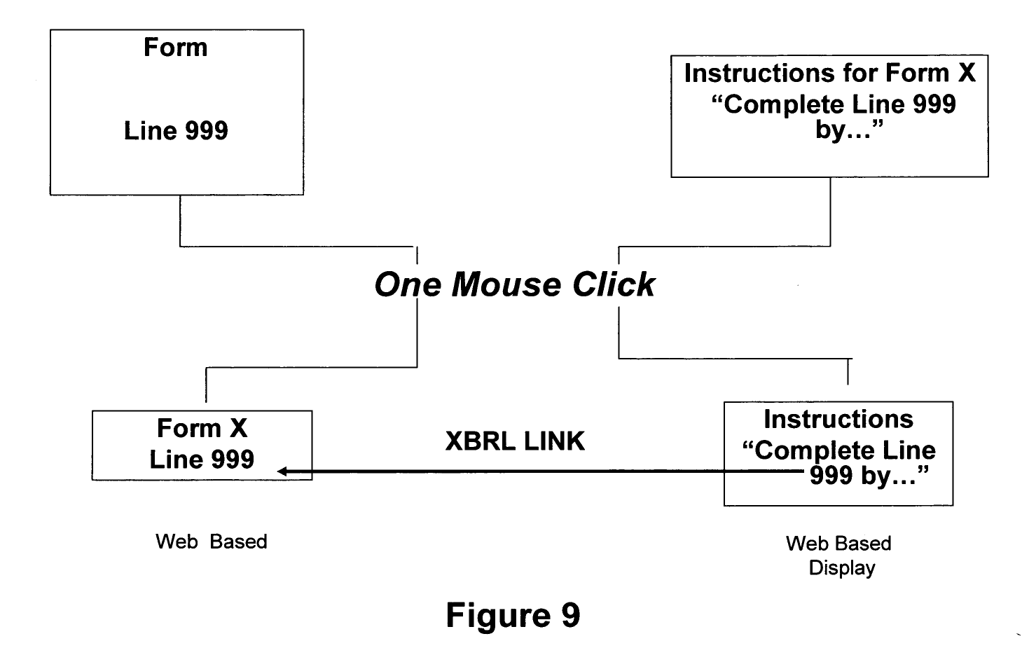

In the simplest embodiment, using a computer on the web, when a user has a question or doesn't understand the short instructions on the form, they would click once on the blank line to be completed on the form and the relevant complete instruction would appear after one click. The software would have rules programmed into it so that the instructions for line x were displayed when line x were clicked. (FIG. 9) If the instructions were more than one page, the user could scroll through them without clicking the computer again. In another embodiment, the instructions could be displayed in an order pre-determined by the preparer of the form and instructions.

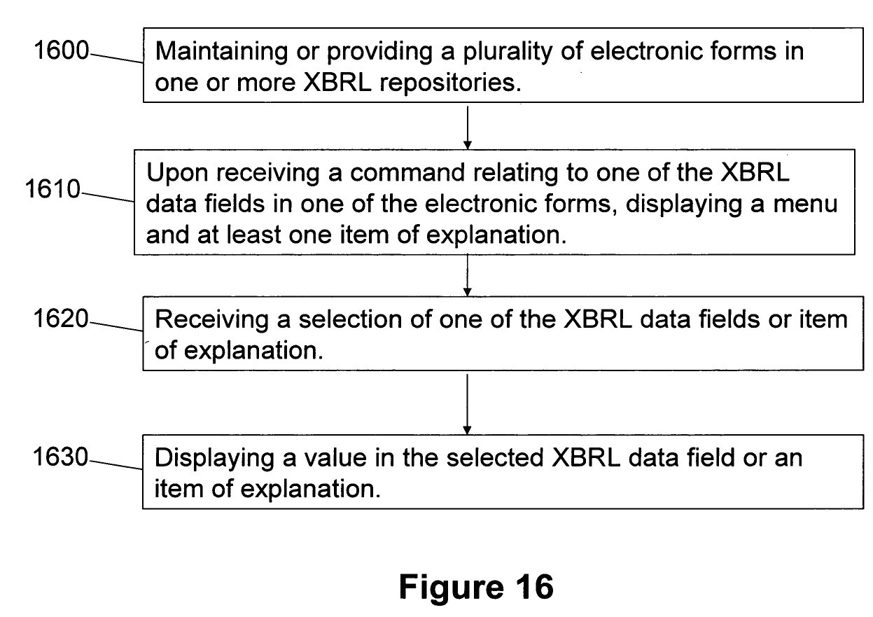

Referring now to FIG. 16, there is illustrated one embodiment of a method for displaying one or more forms. Block 1600 comprises an operation of maintaining or providing a plurality of XBRL electronic forms in one or more data repositories, each of the forms comprising a plurality of XBRL data fields having metadata according to a form taxonomy, each of a plurality of the XBRL data fields on one of the electronic fields being linked to at least one XBRL data field in one or more other of the XBRL electronic forms, and to at least one item of explanation data relating to completing the form.

In one embodiment, one or more of the forms are tax forms. In this embodiment, one or more of the forms can be tax forms from prior years, federal tax forms, state tax form, or local tax forms, to name a few. In another embodiment, the forms are forms to be completed for a government agency. In another embodiment, the forms are forms to be completed to obtain a license or permit. In another embodiment, the forms are patient medical forms (including admittance forms, insurance forms, or liability forms, to name a few).

Block 1610 comprises an operation of upon receiving a command relating to one of the XBRL data fields in one of the electronic forms, displaying a menu of one or more XBRL data fields in the one or more other forms and at least one item of explanation. In one embodiment, this menu is a drop down menu. In another embodiment, this menu is a pop-up menu. However, the term “menu” is intended to be interpreted broadly to cover any type of format.

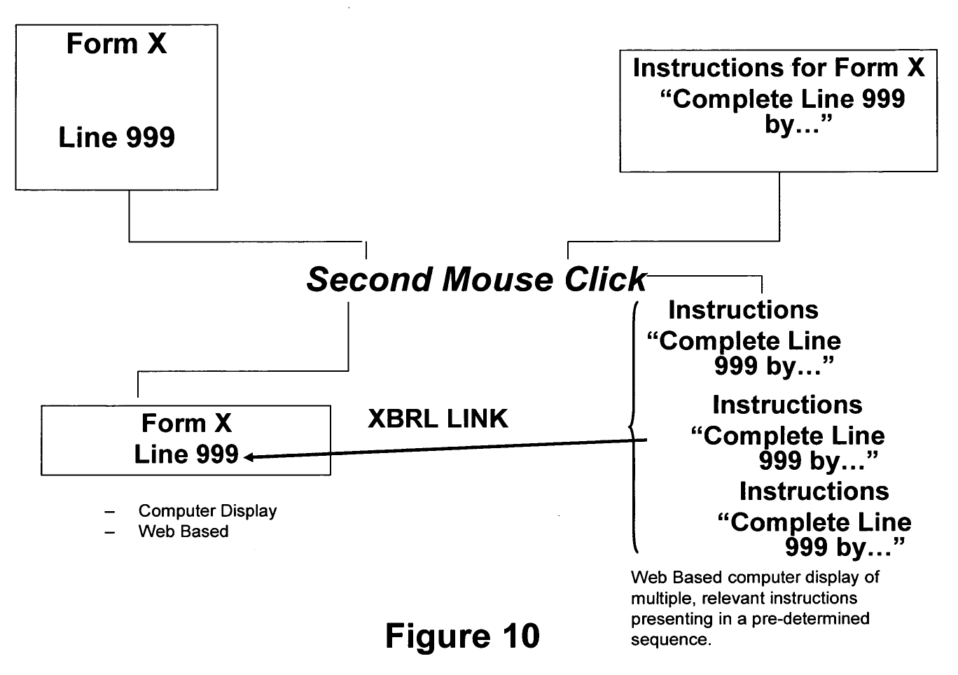

In another embodiment, in the event that more than one instruction (sentence, paragraph, and chapter) is relevant to the line completed in the form, the first click in the software will produce a drop down type display allowing the user to identify the instruction that they believe is most relevant and want to read. Other embodiments may rank the electronically linked instructions displayed electronically by the first click by the most often used instruction, alphabetically, or some other predetermined sequence that permits the user to view a number of instruction, then click on the instruction they think is most appropriate. In that case, the individual completing the form would be two clicks away from displaying the instructions they have chosen to read. In another embodiment, the provider of the form can rank the linked instructions using their own criteria for ranking for display. (FIG. 10)

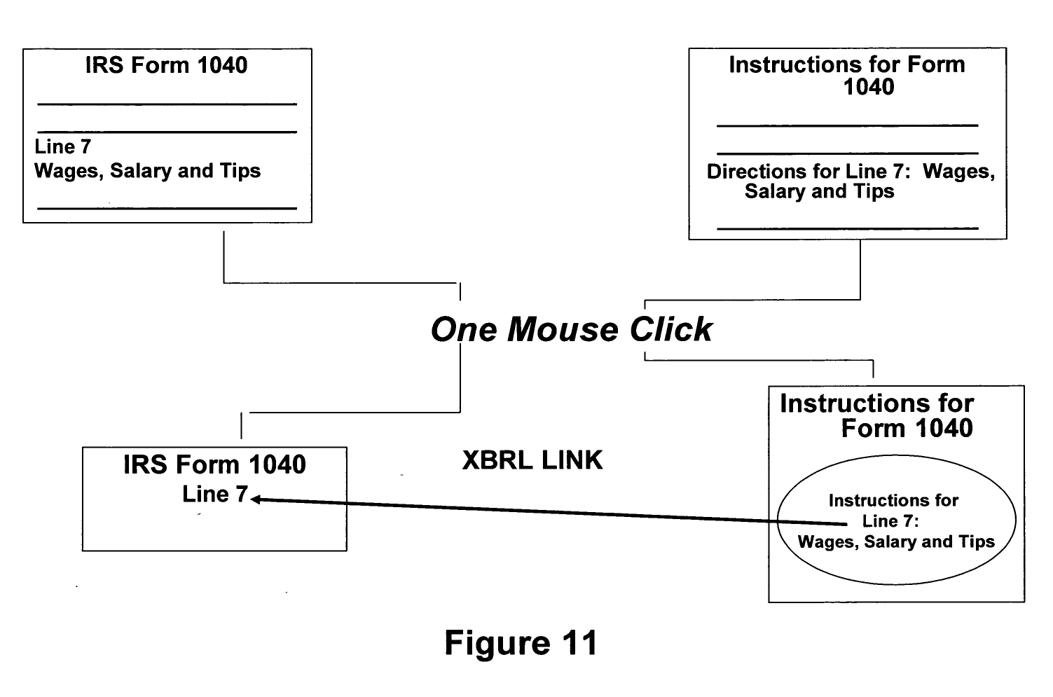

In the case of the Internal Revenue Service and its Form 1040, the individual completing the Form 1040 would click on the relevant line they are completing and the IRS Instructions Manual for the particular line on the 1040 would be displayed. Pre-determined computer rules ensure that the correct instructions for the line are linked, and electronically retrieved, transmitted and displayed for the individual line on the 1040 when the line on the 1040 is clicked. In XBRL software parlance, opening the IRS 1040 form produces an “instance document”. Utilizing XBRL's linking capabilities, the IRS Instructions Booklet is an external document (external to the 1040 form) that is electronically linked by the sentence or paragraph to the relevant individual line on the XBRL 1040 form. (FIG. 11)

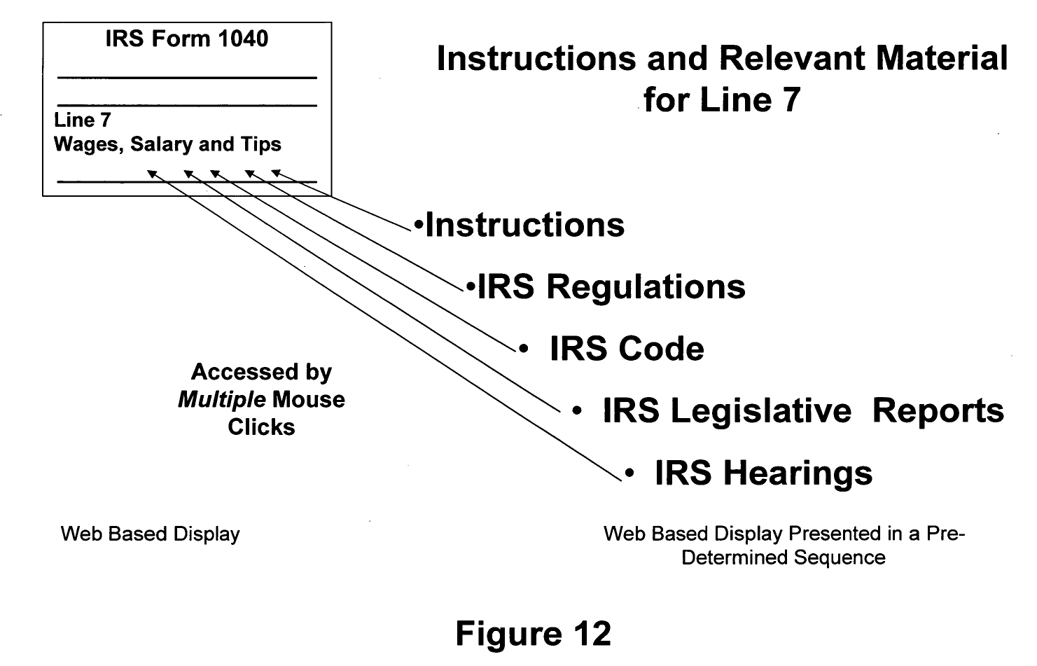

In another embodiment, the initial click of the mouse on a particular line of an IRS 1040 form can produce a drop down menu of relevant sections of the Instructions. In turn, a second click of the mouse can produce an electronically linked set of references in IRS Publications. In turn, a third click of the mouse can produce a reference to the IRS Regulations that relate to the individual line in the 1040 Form to be completed. In turn, a fourth click of the computer mouse can produce the section of the Internal Revenue Code that relates to the individual line in the IRS Form 1040. In turn, a fifth click of the mouse can produce a menu to choose the legislative history of the relevant section of the Code Section for the individual line in the IRS 1040. A fifth click of the mouse can produce a drop down menu of the Congressional legislative hearings on the section of the Code and any relevant background research on it. (FIG. 12) Alternatively, these different levels can be selected via a menu.

In another embodiment, the user can click the computer mouse on the individual line in the Form 1040 and have displayed the value in that data field for the previous year. Another click of the mouse can produce that same field on the IRS 1040 and the user's value for that field for subsequent years. Alternatively, these different levels or years can be selected via a menu.

In another embodiment, the user can click the computer mouse on the individual line in the current year's IRS Form 1040 and be linked to the relevant line on the state income tax for the state that the user lives in to be completed for the state. The computer program can contain the tax rules for the state of the user, determined by the zip code, and make the necessary adjustments and calculations to the line entry in the Federal Form 1040 and complete the state income tax forms for the current year. In turn, these are transmitted and displayed on the user's computer screen.

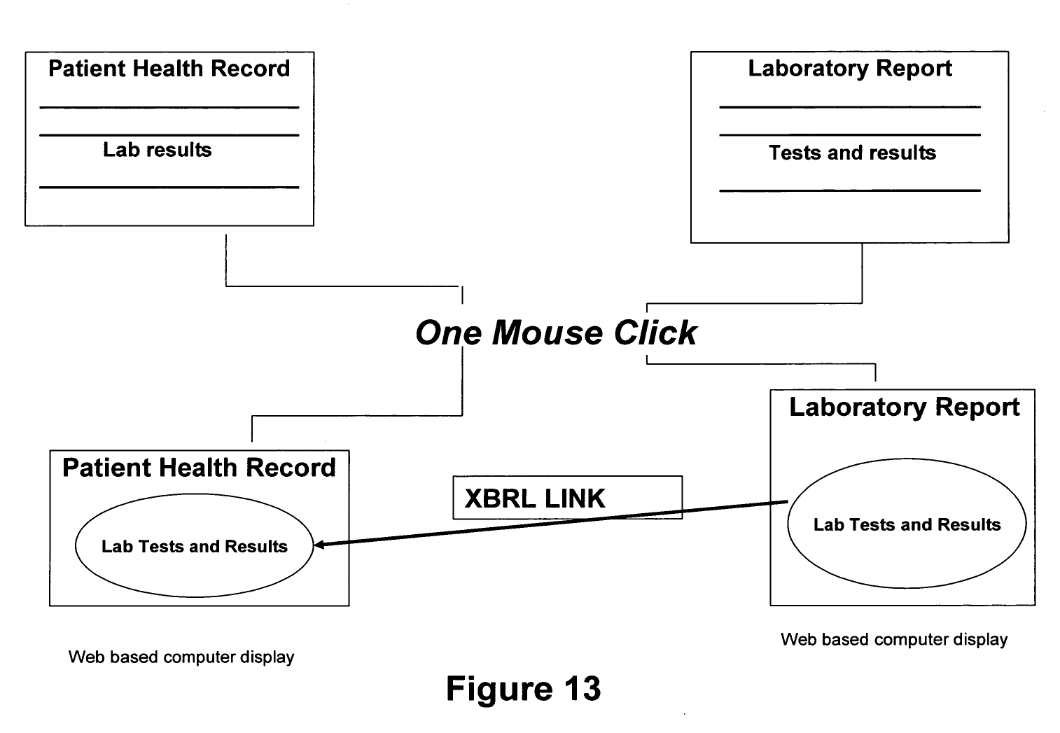

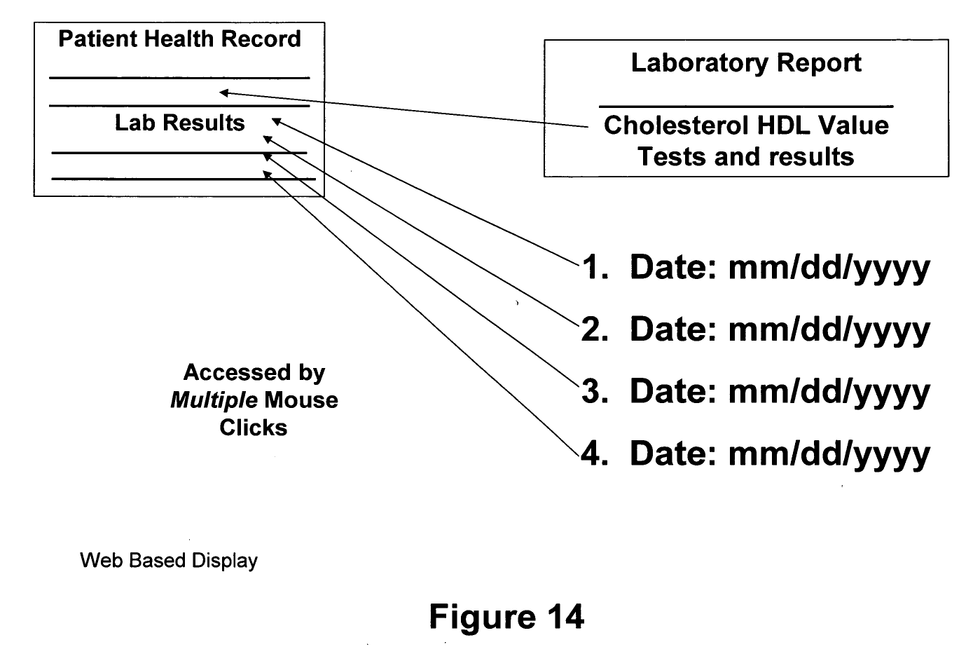

In another embodiment, the instructions for completing a patient form in health care can be linked to the individual line in the form displayed on the web. The instructions are pre-programmed to be certain that the user of the health care form receives the correct instructions linked electronically to the individual item in the health care form to be completed. (FIG. 13) The patient's results for a particular value, e.g. an HDL cholesterol value, can be linked to a variety of other relevant data. For example, the patient's past HDL for previous years can be linked to be displayed by a click or displayed in a graph for visual examination by a physician. (FIG. 14)

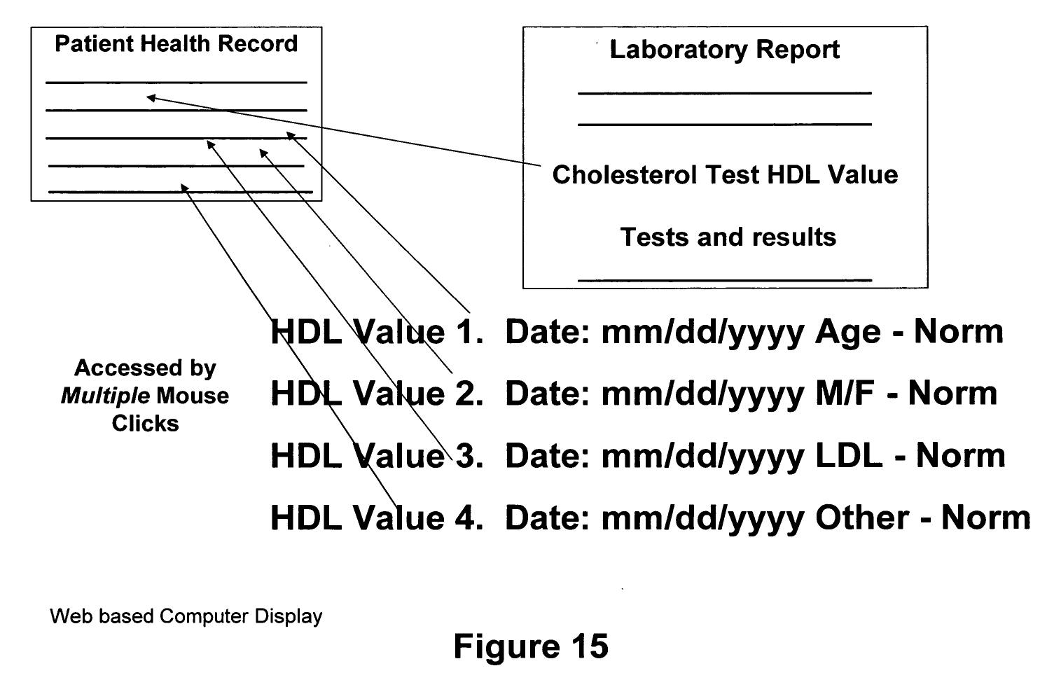

In another embodiment in health care, the current score or value in a patient's health profile, e.g. HDL cholesterol value, can be linked to the medical research about the score or value, and the individual patients ranking against national data, guidelines or other measures of health. On the web a computer form to be completed with current measurements, e.g., blood pressure, can be linked with the indicated range of healthy blood pressure for a person of a particular age, sex, etc. the background information can be displayed with the current value. (FIG. 15)

Referring again to FIG. 16, block 1620 comprises an operation of receiving a selection of one of the one or more XBRL data fields or the item of explanation in the menu. The various embodiments detailed above also show how a selection of one of the one or more XBRL data fields or the item of explanation in the menu is received.

Block 1630 comprises an operation of displaying a value in the selected XBRL data field or displaying the item of explanation. The item of explanation may be displayed as a pop up, or may appear alongside the data field. Further, the item of explanation may have links contained therein, which can be selected in a fashion similar to that detailed above.

A further embodiment is an Extensible Business Reporting Language (“XBRL”) enhanced Extensible Markup Language (“XML”) based software application that is used by an entity to procure goods and services. Over the web, the XML/XBRL application software permits the purchasing entity to specify and broadcast its procurement requirements, and process XBRL standardized responses from vendors.

Using the software, a potential vendor can learn the procuring entity's purchasing specifications and determine whether the vendor's product or services may meet the procurement specifications. Then the vendor can electronically submit its proposed bid to the procuring entity using a standardized taxonomy to ensure that all the bids received by the procuring entity are comparable for analysis.

The procuring entity can compare a number of electronically proposed bids using the XBRL standardized taxonomy or formats that are electronically comparable. The technical specifications for the purchasing entity's requirements, price, and other service considerations may also be included in the taxonomy or in a separate data base and used for determining the variances of the bids. The procuring entity can select a vendor and notify the vendor that the purchasing entity wishes to purchase the tendered goods or services. Payment is arranged, and the vendor provides the goods or services to the purchasing entity. The software then tracks the delivery of the procured goods and services, their delivery and disbursement within the purchasing entity, and tracks the use of the goods and services, including providing entries to the purchasing entity's general ledger. The input of data to permit this tracking may be accomplished by any convenient entry means including direct or indirect entry from a PDA by service personnel.

The software also permits the electronic linking of external memoranda relating to the procurement and the entry of the relevant data into the procuring entity's accounting system. With one click of a computer mouse, a procuring entity can locate and electronically read an external memorandum that explains the procurement specifications, vendors' submission, its acceptance, and entry into the procuring entity's accounting system. This ensures that a user can electronically locate a related procurement memorandum prepared before, at the time, or after the data entry that explains the data entry or other relevant information to the financial entry relating to the procurement.

Some embodiments ensure that the relevant memorandum will be located and electronically linked to procuring entity's accounting system data entry. This feature eliminates human searches and the errors that human searches can introduce to relating the accounting entry to the rationale or justification for the accounting entry. This saves time and increases accuracy when managing any multi vendor, multi-location, or multi-year contract, or subsequently performing an audit of the procurement contract. The information can be transmitted electronically and displayed remotely.

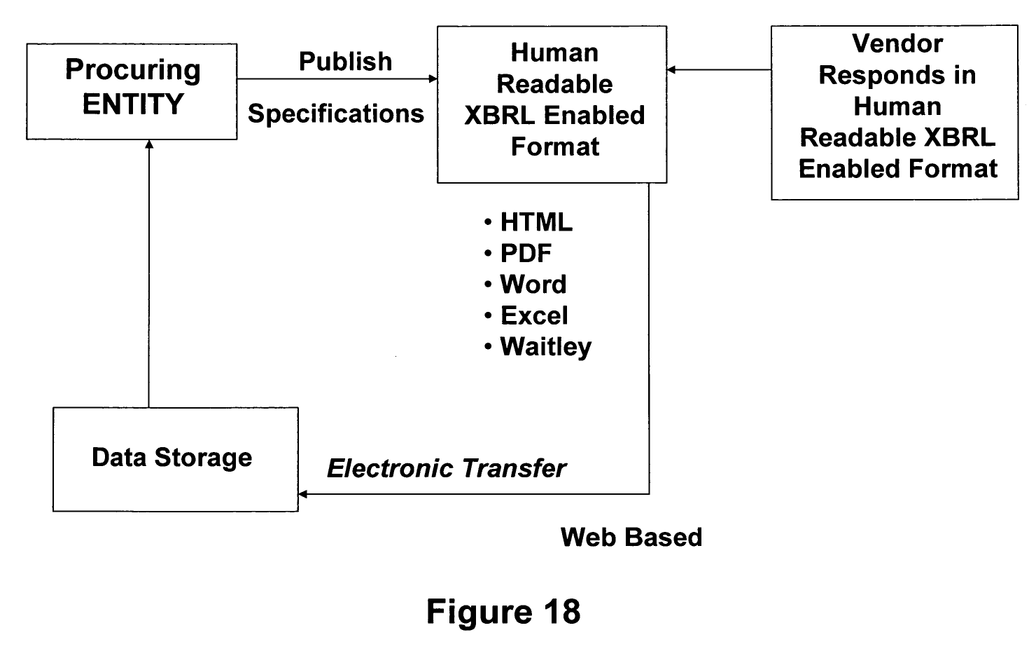

In all of the following embodiments, the XBRL procurement software will have two components; a human readable component, and the computer machine readable component. Examples of the human readable component are current software programs such as Word, Excel, or displays using HTML or PDF data formats. The procurement specifications, vendor responses, etc. would be transmitted and displayed in human readable and XBRL machine readable formats. All of these software or data formats could be XBRL enabled so that in machine language or machine readable format, the data would have been standardized using an XBRL taxonomy and XBRL processor to normalize the data and make it machine readable in XBRL. A human reading the transmitted computer display or completing the formatted request for bids would see only the human readable format they are used to seeing, e.g. an Excel spread sheet format. However, that Excel spread sheet or other XBRL enabled human readable software would be automatically processed into XBRL for the computer. The computer would perform any operations on data in the XBRL format and transmit and display it in human readable format for human consumption. (See FIG. 18.)

In one embodiment, a vendor may have a forms-based submission. The vendor will complete a form hosted by an application such as Microsoft Excel or Word on a web browser. The XBRL software will normalize and convert the data in the form to standard XBRL taxonomy requirements, and make it available in its native XBRL format (as submitted), as well as in Adobe Acrobat (PDF) and Web-based (HTML) formats. These formats can then be transmitted and displayed in multiple locations within the procuring entity as human-readable versions of standardized procurement forms, and transmitted and stored in the procuring entity's document management system. This is a direct data entry form with the submitted data residing on the procuring entity's operated server.

In a second embodiment, a spreadsheet-based client side application, such as Microsoft Excel with an XBRL-enabled plug-in, with data submitted to the procuring entity's server through a web browser-based file upload form. This embodiment provides the full power and flexibility of a spreadsheet, while allowing the validation logic in the XBRL taxonomy to reside outside the spreadsheet, where it can be more easily updated, upgraded and standardized by the procuring entity.

In a third embodiment, an XBRL-enabled data converter is customized to the vendors reporting system, with data submitted through a Web browser-based file up load form. Here a vendor may have an electronic submission, which is a file-based interface that receives preformatted data extracts directly from the procuring entity's systems transmitted via the internet, web mail, cellular phone, or other electronic devices. In this embodiment, a vendor can be a remote terminal and download the procuring entity's procurement specifications from the procuring entity's server to the vendor's remote terminal where the vendor completes the file to the procuring entity's predetermined standards.

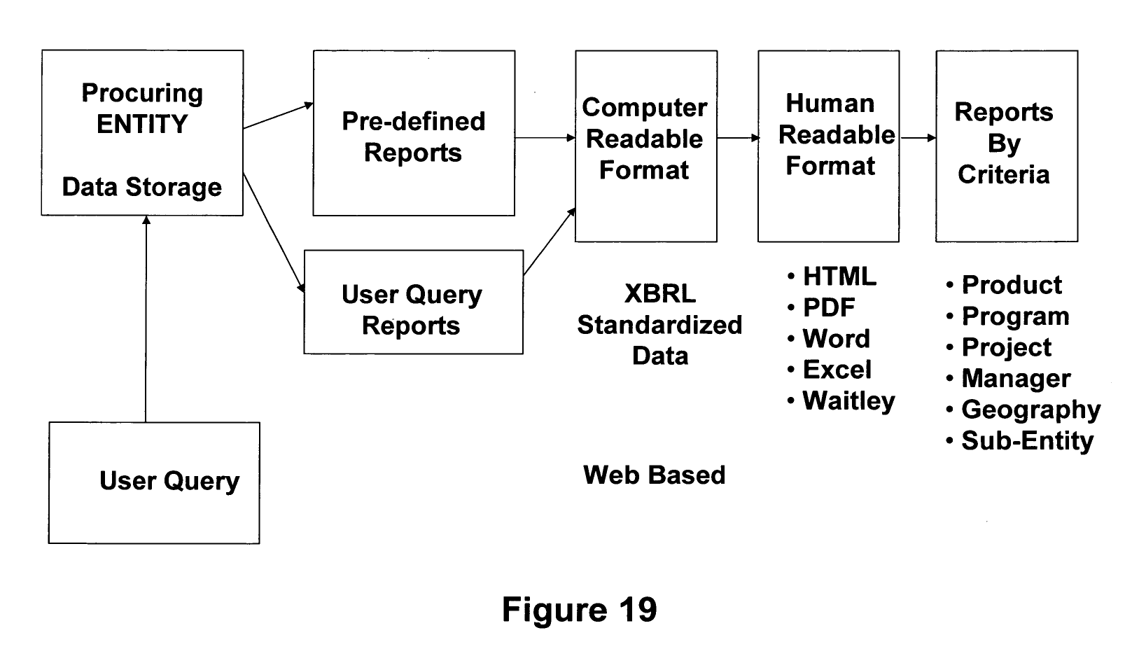

Having completed a file in the XBRL standardized format that has been transmitted from the procuring agency's server, the vendor completes the human readable form, which in turn prepares the electronic file. The software will then normalize and convert the inputted data to standard structure requirements, and make it available in its native XBRL format (as submitted), as well as in Adobe Acrobat (PDF) and Web-based (HTML) formats. These formats can then be transmitted and displayed in multiple locations within the procuring entity as human-readable versions of standardized procurement forms, and transmitted and stored in the procuring entity's document management system. (See FIG. 19)

In one embodiment, the procuring entity can publish on the Internet or on an intranet, its procurement requirements and the purchase specifications for each item it wishes to purchase. They are in XBRL standardized taxonomy. A vendor may upload and view the specifications, electronically compare his goods using a standardized taxonomy and determine whether his goods meet the standards and how they may not meet the standard.

The vendor can then submit the product standards for comparison by the procuring vendor using the XBRL standardized forms. The variances can be highlighted and submitted with a bid with price adjustments made to reflect the differences. The vendor can then submit a price bid reflecting the comparison of the procuring entity's product requirement standards and the vendors offering using comparable XBRL standards. This vendor submission electronic document is then received by the procurement entity.

The procuring entity can receive the electronically submitted bids and procurement standards, rank and evaluate the submitted bids using pre-determined criteria to determine the rank order of the bids by price, or other criteria. The XBRL based bid can then be accepted on the system, the order transmitted to the vendor and a report of the ordered goods transmitted electronically to the procuring entity's accounting records and document management system.

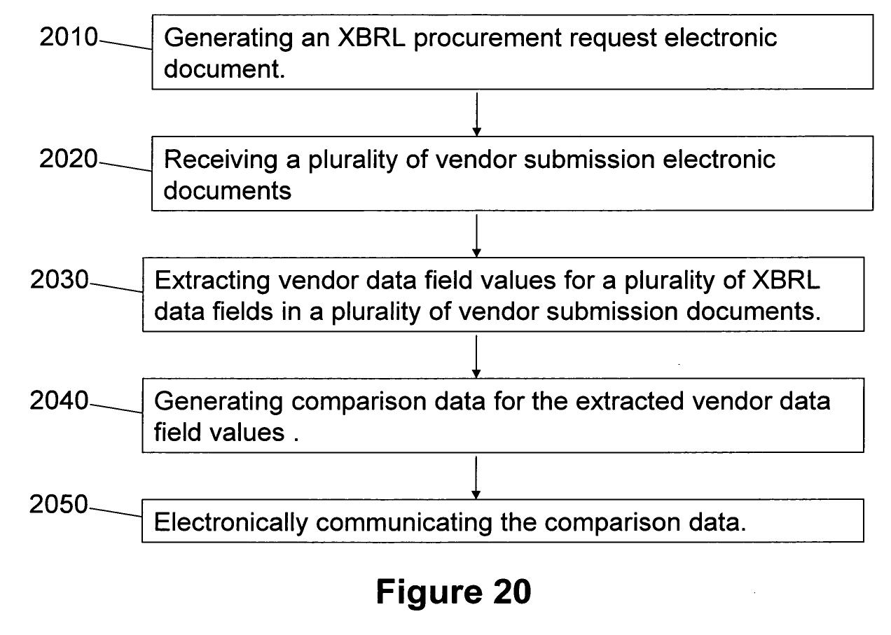

Referring now to FIG. 20, there is illustrated one embodiment of a method for facilitating procurement.

Block 2010 comprises an operation of generating an XBRL procurement request electronic document comprising a plurality of XBRL data fields, with each of a plurality of data fields having associated components representing attributes at the data value level in the data field based on a taxonomy, and forming links between and/or among at least two items selected from one or more of the categories of the data fields, metadata and components associated with the data fields in the XBRL procurement request. In one embodiment, the taxonomy is a general ledger taxonomy.

In one embodiment, the XBRL procurement request electronic document may include an XBRL buyer data field value for a plurality of XBRL data fields. The variance between a plurality of the vendor data field's values and XBRL buyer data field values for the respective data fields may be determined. This variance can then be electronically communicated for the plurality of vendor data field values.

Block 2020 comprises an operation of receiving a plurality of vendor submission electronic documents, with each vendor submission electronic document comprising, either as originally received or after conversion in a suitable XBRL conversion engine based on a procurement taxonomy, a plurality of the XBRL data fields completed with one or more vendor data field values. The different methods of vendor submission are detailed above, and are not limiting on the invention.

Block 2030 comprises an operation of extracting vendor data field values, and the associated components, for a plurality of the XBRL data fields in a plurality of the vendor submission electronic documents. These data field values, and their components, are then utilized to determine which bid to accept. The field values may include a buyer's requirements such as, price, geographic location of bidder, time needed to complete the bid project, and other service considerations, to name a few.

Block 2040 comprises an operation of generating comparison data for the extracted vendor data field values and associated components for a plurality of the XBRL data fields. The procuring entity can compare a number of electronically proposed bids using the XBRL standardized taxonomy or formats that are electronically comparable to their technical specifications for one or a plurality of the field values extracted above. In one embodiment, the comparison data generated is the variance data discussed above. In one embodiment, a plurality of vendor submission electronic documents are ranked based upon the variances determined for a plurality of data fields.

Block 2050 comprises an operation of electronically communicating the comparison data. The communication operation may be implemented by a presentation on a video display on any convenient electronic device, or via a communication of a text message, or a paper printout, or a printing or communication of a barcode, or via an email, or via a network communication, or a Web service, or an RFID tag, or any other mode of communication. In one embodiment, the communication may be made to a video screen in an office or conference room. In another embodiment, the communication may be a network communication to an electronic database. The communication mode is not limiting on the invention.

In one embodiment, a contract award notice to a submitting vendor may be electronically communicated. That is, after the comparison of bids has been completed, a bid may be chosen. In one embodiment, the XBRL based bid may be accepted on the system based on one or more criteria, and the order electronically transmitted to the vendor and a report of the ordered goods transmitted electronically to the procuring entity's accounting records and document management system.

In one or more embodiments, the user of the XBRL procurement software can retrieve the data and analyze it using predetermined criteria, then transmit the data electronically over the internet or an intranet and display it remotely. This permits the analysis of goods and services procured by geographic region, vendor, project or program.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A method for integrating intelligence systems, comprising:
receiving a search query;
searching, using the search query, a plurality of XBRL data fields in records in a plurality of different data repositories, with each of the XBRL data fields having metadata representing attributes at the data value level based on context data according to an information taxonomy, and with links formed between and/or among at least two items selected from one or more of the categories of data fields, metadata, and components associated with the data fields, the searching obtaining a search result;
triggering the creation of an electronic agency communication of at least a partial version of the search result; and
communicating the at least a partial version of the search result;
wherein the content or addressee of the electronic agency communication is determined, at least in part, by the value of an importance factor related to one or more data items returned in the search result.

2. The method of claim 1, wherein the importance factor is part of the metadata of the data fields.

3. The method of claim 1, wherein the importance factor is calculated based upon the one or more data items returned in the search result.

4. The method of claim 1, wherein the importance factor is calculated by an algorithm that utilizes the search result.

5. The method of claim 1, wherein, if the importance factor of one of the data items returned in the search result is marked as high, or its equivalent, the agency communication is composed with a warning indication.

6. The method of claim 1, wherein, if the importance factor of one of the data items returned in the search result is marked as high, or its equivalent, a second agency communication is composed to a high-level official in the agency.

7. The method of claim 6, wherein the second agency communication is composed with a warning indication.

8. The method of claim 1, wherein, if the importance factor of one of the data items returned in the search result is marked as high, or its equivalent, multiple agency communications are composed.

9. The method of claim 8, wherein at least one of the agency communications is marked with a warning indication.

10. The method of claim 8, wherein the agency communications are communicated to a plurality of different agencies.

11. The method as defined in claim 1, wherein the search query comprises one or more of a time, a date, a nationality, a mode of transportation, a person's name, a person's regional affiliation, a location, and a transported item.

12. The method as defined in claim 1, wherein at least one item in the search results has a communication restriction data linked thereto, and
including a designation of the at least one item and an explanation or a link to an explanation of the legal communication restriction data.

13. The method as defined in claim 12, wherein display data for the designation for the at least one item includes a link to initiate a request for permission to disclose the at least one item.

14. The method as defined in claim 1, wherein at least one item in the search results has a communication restriction data linked thereto, and further comprising
automatically initiating a request for permission to disclose the at least one item.

15. The method as defined in claim 1, wherein the search query comprises one or more of a person's name, a person's regional affiliation, a date, a location, a mode of transportation, and a transported item.

16. The method as defined in claim 1, wherein the search query is based on a convergence algorithm and searches for XBRL data fields with metadata relating to a period of time, a geographic location, and/or a mode of transportation.

17. The method as defined in claim 1, further comprising performing a convergence algorithm on items in the search result.

18. The method as defined in claim 1, further comprising utilizing the search result in an analytical model.

19. The method as defined in claim 1, wherein the search query is automatically generated.

20. The method as defined in claim 1, wherein one or more of plurality of different data repositories contains a government entity XBRL database.

21. A method for integrating intelligence systems, comprising:
receiving a search query;
searching, using the search query, a plurality of XBRL data fields in records in a plurality of different data repositories, with each of the XBRL data fields having metadata representing attributes at the data value level based on context data according to an information taxonomy, and with links formed between and/or among at least two items selected from one or more of the categories of data fields, metadata and components associated with the data fields, the searching obtaining a search result;
composing an electronic agency communication of at least a partial version of the search result; and
communicating the at least partial version of the search results;
wherein one or more of plurality of different data repositories contains a government entity XBRL database.

22. The method as defined in claim 21, wherein the metadata associated with the data field represents one or more of a time, a date, a nationality, a mode of transportation, a person's name, a person's regional affiliation, a location, and a transported item.

23. The method as defined in claim 21, wherein at least one item in the search result has a communication restriction data linked thereto, and
including a designation of the at least one item and an explanation or a link to an explanation of the legal communication restriction data.

24. The method as defined in claim 23, wherein display data for the designation for the at least one item includes a link to initiate a request for permission to disclose the at least one item.

25. The method as defined in claim 21, wherein at least one item in the search result has a communication restriction data linked thereto, and further comprising
automatically initiating a request for permission to disclose the at least one item.

26. The method as defined in claim 21, wherein the search query comprises one or more of a person's name, a person's regional affiliation, a date, a location, a mode of transportation, and a transported item.

27. The method as defined in claim 21, wherein the search query is based on a convergence algorithm and searches for XBRL data fields with metadata relating to a period of time, a geographic location, and/or a mode of transportation.

28. The method as defined in claim 21, further comprising performing a convergence algorithm on items in the search results.

29. The method as defined in claim 21, further comprising utilizing the search results in an analytical model.

30. The method as defined in claim 21, wherein the search query is automatically generated.

31. A program product for integrating intelligence systems, comprising:
one or more computer usable media having computer readable program code embodied therein or among them, to be executed by a computer, the computer readable program code comprising:
program code for receiving a search query;
program code for searching, using the search query, a plurality of XBRL data fields in records in a plurality of different data repositories, with each of the XBRL data fields having metadata representing attributes at the data value level based on context data according to an information taxonomy, and with links formed between and/or among at least two items selected from one or more of the categories of data fields, metadata, and components associated with the data fields, the searching obtaining a search result;
program code for triggering the creation of an electronic agency communication of at least a partial version of the search result; and
program code for communicating the at least partial version of the search result;
wherein the content or addressee of the electronic agency communication is determined, at least in part, by the value of an importance factor related to one or more data items returned in the search result.

32. A system for integrating intelligence systems, comprising:
a data repository; and
one or more processors operably connected to the data repository for implementing the following components:
a component for receiving a search query;
a component for searching, using the search query, a plurality of XBRL data fields in records in a plurality of different data repositories, with each of the XBRL data fields having metadata representing attributes at the data value level based on context data according to an information taxonomy, and with links formed between and/or among at least two items selected from one or more of the categories of data fields, metadata, and components associated with the data fields, the searching obtaining a search result;
a component for triggering the creation of an electronic agency communication of at least partial version of the search result; and
a component for communicating the at least a partial version of the search result;
wherein the content or addressee of the electronic agency communication is determined, at least in part, by the value of an importance factor related to one or more data items returned in the search result.

33. A method for displaying one or more forms, comprising:
maintaining or providing a plurality of XBRL electronic forms in one or more data repositories, each of the forms comprising a plurality of XBRL data fields having metadata and components associated with the data fields according to a form taxonomy, each of a plurality of the XBRL data fields in one of the XBRL electronic forms being linked to at least one XBRL data field or metadata in one or more other of the electronic forms, and to at least one item of explanation data relating to completing the form;
upon receiving a command relating to one of the XBRL data fields in one of the electronic forms, displaying a menu of one or more XBRL data fields in the one or more other forms and at least one item of explanation data;
receiving a selection of one of the one or more XBRL data fields or the item of explanation in the menu; and
displaying a value in the selected XBRL data field or displaying the item of explanation.

34. The method as defined in claim 31, further comprising:
determining if a criterion has been met for display of one or more potential items that may be displayed in the menu; and wherein the displaying a menu step comprises determining which items to display in the menu based on whether the criterion has been met.

35. The method as defined in claim 34, further comprising:
determining if more than one potential item for display exists; and
ranking the items for display.

36. The method as defined in claim 35, wherein the ranking may be done by the most often used instruction.

37. The method as defined in claim 35, wherein the ranking may be done alphabetically.

38. The method as defined in claim 35, wherein the ranking may be done by a predetermined sequence that permits the display of a number of the items for selection.

39. The method as defined in claim 33, wherein the one or more other forms are tax forms.

40. The method as defined in claim 39, wherein the tax forms are prior year tax forms.

41. The method as defined in claim 39, wherein the tax forms are state tax forms.

42. The method as defined in claim 33, wherein the one or more other forms are medical forms.

43. The method as defined in claim 42, wherein medical research can be displayed in relation to the data input to the one or more forms.

44. The method as defined in claim 33, wherein the menu may contain one or more links.

45. The method as defined in claim 33, wherein the forms are for obtaining a license or permit.

46. The method as defined in claim 31, wherein the forms are for a government agency.

47. The method as defined in claim 46, wherein the government agency is the Internal Revenue Service.

48. A program product for displaying one or more forms, comprising:
one or more computer usable media having computer readable program code embodied therein or among them, to be executed by a computer, the computer readable program code comprising:
program code for maintaining or providing a plurality of XBRL electronic forms in one or more data repositories, each of the forms comprising a plurality of XBRL data fields having metadata and components associated with the data fields according to a form taxonomy, each of a plurality of the XBRL data fields in one of the XBRL electronic forms being linked to at least one XBRL data field or metadata in one or more other of the electronic forms, and to at least one item of explanation data relating to completing the form;
program code for, upon receiving a command relating to one of the XBRL data fields in one of the electronic forms, displaying a menu of one or more XBRL data fields in the one or more other forms and at least one item of explanation data;
program code for receiving a selection of one of the one or more XBRL data fields or the item of explanation in the menu; and
program code for displaying a value in the selected XBRL data field or displaying the item of explanation.

49. A system for displaying one or more forms, comprising:
a data repository; and
one or more processors operably connected to the data repository for implementing the following components:
a component for maintaining or providing a plurality of XBRL electronic forms in one or more data repositories, each of the forms comprising a plurality of XBRL data fields having metadata and components associated with the data fields according to a form taxonomy, each of a plurality of the XBRL data fields in one of the XBRL electronic forms being linked to at least one XBRL data field or metadata in one or more other of the electronic forms, and to at least one item of explanation data relating to completing the form;
a component for, upon receiving a command relating to one of the XBRL data fields in one of the electronic forms, displaying a menu of one or more XBRL data fields in the one or more other forms and at least one item of explanation data;
a component for receiving a selection of one of the one or more XBRL data fields or the item of explanation in the menu; and
a component for displaying a value in the selected XBRL data field or displaying the item of explanation.

50. A method for facilitating procurement, comprising:
generating an XBRL procurement request electronic document comprising a plurality of XBRL data fields, with each of a plurality of data fields having associated components representing attributes at the data value level in the data field based on a taxonomy, and forming links between and/or among at least two items selected from one or more of the categories of the data fields, metadata and components associated with the data fields in the XBRL procurement request electronic document;
receiving a plurality of vendor submission electronic documents, with each vendor submission electronic document comprising a plurality of the XBRL data fields completed with one or more vendor data field values;
extracting vendor data field values for a plurality of the XBRL data fields in a plurality of the vendor submission electronic documents;
generating comparison data for the extracted vendor data field values for a plurality of the XBRL data fields; and
electronically communicating the comparison data.

51. The method as defined in claim 50, wherein the taxonomy is a general ledger taxonomy.

52. The method as defined in claim 50, wherein the XBRL procurement request electronic document includes an XBRL buyer data field value for a plurality of the XBRL data fields;
determining a variance, if any, between each of a plurality of the vendor data field values and the respective XBRL buyer data field value for that data field; and
electronically communicating this variance for the plurality of the vendor data field values.

53. The method as defined in claim 50, further comprising ranking a plurality of the vendor submission electronic documents based on the variances determined for a plurality of the data fields.

54. The method as defined in claim 50, further comprising electronically communicating a contract award notice to a submitting vendor for one of the vendor submission electronic documents.

55. A program product for facilitating procurement, comprising:
one or more computer usable media having computer readable program code embodied therein or among them, to be executed by a computer, the computer readable program code comprising:
program code for generating an XBRL procurement request electronic document comprising a plurality of XBRL data fields, with each of a plurality of data fields having associated components representing attributes at the data value level in the data field based on a taxonomy, and forming links between and/or among at least two items selected from one or more of the categories of the data fields, metadata and components associated with the data fields in the XBRL procurement request electronic document;
program code for receiving a plurality of vendor submission electronic documents, with each vendor submission electronic document comprising a plurality of the XBRL data fields completed with one or more vendor data field values;
program code for extracting vendor data field values for a plurality of the XBRL data fields in a plurality of the vendor submission electronic documents;
program code for generating comparison data for the extracted vendor data field values for a plurality of the XBRL data fields; and
program code for electronically communicating the comparison data.

56. A system for facilitating procurement, comprising:
a data repository; and
one or more processors operably connected to the data repository for implementing the following components:
a component for generating an XBRL procurement request electronic document comprising a plurality of XBRL data fields, with each of a plurality of data fields having associated components representing attributes at the data value level in the data field based on a taxonomy, and forming links between and/or among at least two items selected from one or more of the categories of the data fields, metadata and components associated with the data fields in the XBRL procurement request electronic document;
a component for receiving a plurality of vendor submission electronic documents, with each vendor submission electronic document comprising a plurality of the XBRL data fields completed with one or more vendor data field values;
a component for extracting vendor data field values for a plurality of the XBRL data fields in a plurality of the vendor submission electronic documents;
a component for generating comparison data for the extracted vendor data field values for a plurality of the XBRL data fields; and
a component for electronically communicating the comparison data.
